(19) United States
(12) Patent Application Publication
(10) Pub. No.: US 2017/0316689 A1
(43) Pub. Date: Nov. 2, 2017

(54) PICKUP COORDINATION SYSTEM AND METHOD

(71) Applicant: zoomX, Inc., San Francisco, CA (US)

(72) Inventors: Tim Houts, San Francisco, CA (US); Eric Moe, Point Richmond, CA (US)

(21) Appl. No.: 15/583,929

(22) Filed: May 1, 2017

Related U.S. Application Data
(60) Provisional application No. 62/330,725, filed on May 2, 2016.

(51) Int. Cl. G08G 1/123; G06Q 50/20; H04L 29/08; H04W 4/02

(52) U.S. Cl. CPC G08G 1/123; H04W 4/025; G06Q 50/205; H04L 67/26

(57) ABSTRACT

A system that coordinates pickups of entities to be picked up includes a number of monitor devices, a number of authorized pickup entity devices, at least one communications network, at least one time to arrival estimation server, at least one coordination server, and at least one administration server. Each of the time to arrival estimation server, coordination server, and administration server may have respective databases stored on respective nontransitory computer- or processor-readable media. The coordination server permits interaction between the monitor devices and authorized pickup entity devices while maintaining privacy of entities logically associated with such devices and while addressing a plurality of technical problems that one of ordinary skill in the art may face when implementing the system that coordinates pickups.

### BACKGROUND

### Technical Field

This disclosure generally relates to pickup coordination, for example, with regard to students or packages.

### Description of the Related Art

A school may dismiss students of the school after completion of classes for a school day. Parents may pick up the students upon or after dismissal of the students.

### BRIEF SUMMARY

A method of coordinating pickups may be summarized as including: for each of a plurality of entities to be picked up, storing respective pickup instructions to at least one nontransitory computer-readable medium, the stored pickup instructions which specify an entity authorized to pick up the respective entity to be picked up; and at least within a first threshold time of a scheduled pickup: determining, by at least one processor, an estimated time to arrival of the entity authorized to pick up the respective entity to be picked up; and providing, by at least one processor, the estimated time to arrival of the entity authorized to pick up the respective entity to be picked up to a device logically associated with a monitor entity that monitors the respective entity to be picked up until the respective entity to be picked up is picked up by the entity authorized to pick up the respective entity to be picked up.

A system that coordinates pickups may be summarized as including: at least one processor; at least one non-transitory computer-readable medium communicatively coupled to the at least one processor, the at least one non-transitory computer-readable medium which stores at least one of processor-executable instructions or data, which when executed by the at least one processor cause the at least one processor to: for each of a plurality of entities to be picked up, store respective pickup instructions to the at least one nontransitory computer-readable medium, the stored pickup instructions which specify an entity authorized to pick up the respective entity to be picked up; and at least within a first threshold time of a scheduled pickup: determine an estimated time to arrival of the entity authorized to pick up the respective entity to be picked up; and provide the estimated time to arrival of the entity authorized to pick up the respective entity to be picked up to a device logically associated with a monitor entity that monitors the respective entity to be picked up until the respective entity to be picked up is picked up by the entity authorized to pick up the respective entity to be picked up.

A system that coordinates pickups may be summarized as including: at least one processor; at least one non-transitory computer-readable medium communicatively coupled to the at least one processor, the at least one non-transitory computer-readable medium which stores at least one of processor-executable instructions or data, which when executed by the at least one processor cause the at least one processor to: for each of a plurality of entities to be picked up, store respective pickup instructions to the at least one nontransitory computer-readable medium, the stored pickup instructions which specify an entity authorized to pick up the respective entity to be picked up; and at least within a first threshold time of a scheduled pickup: determine an estimated time to arrival of the entity authorized to pick up the respective entity to be picked up; and provide the estimated time to arrival of the entity authorized to pick up the respective entity to be picked up to a device logically associated with a monitor entity that monitors the respective entity to be picked up until the respective entity to be picked up is picked up by the entity authorized to pick up the respective entity to be picked up.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic view of an environment in which a system coordinates pickups according to at least one illustrated implementation, the system including devices logically associated with respective authorized entities authorized to pick up respective entities to be picked up, devices logically associated with respective monitor entities, at least one communications network, and at least one coordination server that communicably couples to at least one of the devices logically associated with respective ones of the authorized entities via the communications network and at least one of the devices logically associated with respective ones of the monitor entities via the communications network.

FIG. 2 is a block diagram of the system that coordinates pickups of FIG. 1 according to at least one illustrated implementation, better illustrating various components of the coordination server of FIG. 1, monitor devices logically associated with respective monitors, and authorized pickup entity devices logically associated with respective authorized entities, all communicatively coupled by the communications network.

FIG. 3 is a high level flow diagram of a coordination of pickups method executable by coordination server of FIG. 1, according to at least one illustrated implementation.

FIG. 4 is a high level flow diagram of a coordination of pickups method executable by coordination server of FIG. 1, according to at least one illustrated implementation.

FIG. 5 is a high level flow diagram of a coordination of pickups method executable by the various components of the system of FIG. 1 authorized pickup entity device, according to at least one illustrated implementation.

FIG. 6 is a screen shot of an authorized pickup entity graphical user interface that a browser of an authorized pickup entity device of FIG. 1 may display, according to at least one illustrated implementation.

FIG. 7 is a screen shot of an authorized pickup entity graphical user interface that an authorized pickup entity application of an authorized pickup entity device of FIG. 1 may display, according to at least one illustrated implementation.

FIG. 8 is a screen shot of an authorized pickup entity graphical user interface that an authorized pickup entity device of FIG. 1 may display to permit editing at least one dismissal or carpool instruction, according to at least one illustrated implementation.

FIG. 9 is a screen shot of an authorized pickup entity graphical user interface that an authorized pickup entity device of FIG. 1 may display with an untamperable date or time stamp, according to at least one illustrated implementation.

FIG. 10 is a screen shot of a monitor graphical user interface that a monitor device of FIG. 1 may display, according to at least one illustrated implementation.

FIG. 11 is screen shot of a monitor graphical user interface that a monitor device of FIG. 1 may display with an estimated time to arrival status and an estimated time to arrival of “en route,” according to at least one illustrated implementation.

FIG. 12 is screen shot of a monitor graphical user interface that a monitor device of FIG. 1 may display with an estimated time to arrival status and an estimated time to arrival of “approaching,” according to at least one illustrated implementation.

FIG. 13 is screen shot of a monitor graphical user interface that a monitor device of FIG. 1 may display with an estimated time to arrival status and an estimated time to arrival of “here,” according to at least one illustrated implementation.

FIG. 14 is screen shot of a monitor graphical user interface that a monitor device of FIG. 1 may display with an untamperable date or time stamp, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with networked and non-networked communications, for example, firewalls, routers, switches, cellular base stations, cellular networks, cloud storage devices, etc., have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

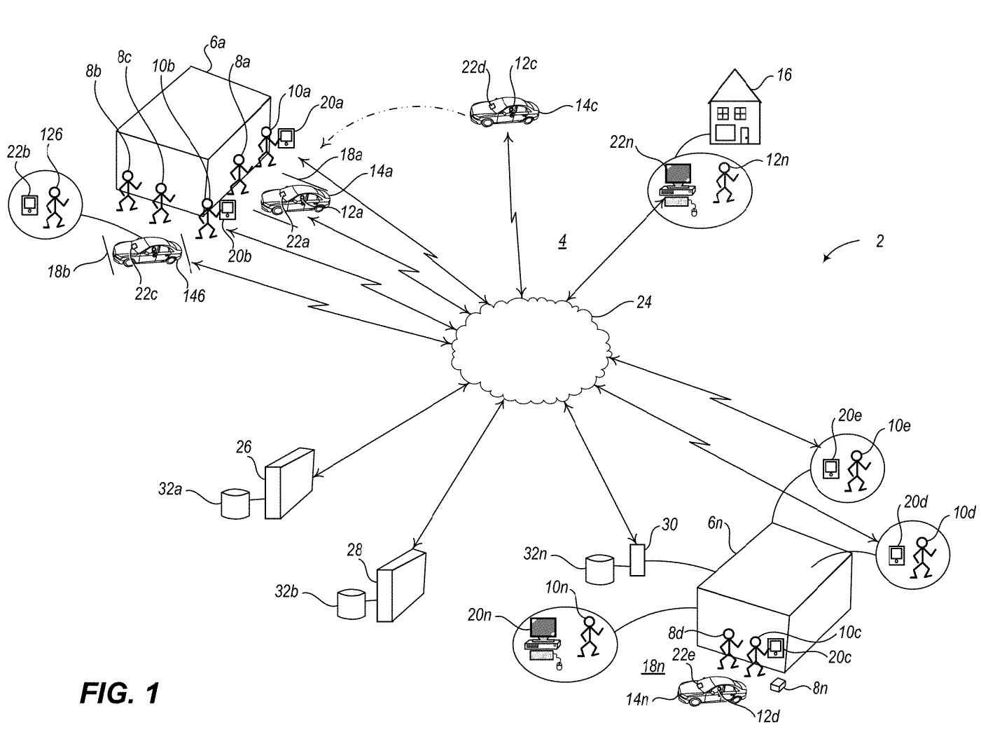

FIG. 1 shows an environment 4 in which a system 2 coordinates pickups, according to at least one illustrated implementation.

The environment 4 may include a number of facilities 6a-6n (collectively 6; only two shown), a number of entities to be picked up 8a-8n (collectively 8; only five shown), a number of monitors 10a-10n (collectively 10; only six shown), a number of authorized entities 12a-12n (collectively 12; only five shown), a number of vehicles 14a-14n (collectively 14; only four shown), and a residence 16 (only one shown). Each facility 6 may have a number of respective pickup zones or locations 18a-18n (collectively 18; only three shown).

A first facility 6a may have a first pickup zone or location 18a and a second pickup zone or location 18b. A first entity to be picked up 8a may wait at the first pickup zone or location 18a. A second entity to be picked up 8b and a third entity to be picked up 8c may wait at the second pickup zone or location 18b. A first monitor 10a may monitor the first entity to be picked up 8a at the first pickup zone or location 18a. A second monitor 10b may monitor the second entity and the third entity to be picked up 8b, 8c at the second pickup zone or location 18b. A first authorized entity 12a authorized to pick up the first entity to be picked up 8a may arrive at the first pickup zone or location 18a in a first vehicle 14a. A second authorized entity 12b authorized to pick up the second entity to be picked up 8b may arrive at the second pickup zone or location 18b in a second vehicle 14b. A third authorized entity 12c authorized to pick up the third entity to be picked up 8c may be en route to the first facility 6a in a third vehicle 14c.

A second facility 6n may have a third pickup zone or location 18n. A fourth entity to be picked up 8d and a fifth entity to be picked up 8n may wait at the third pickup zone or location 18n. A third monitor 10c may monitor the fourth and fifth entities to be picked up 8d, 8n at the third pickup zone or location 18n. A fourth monitor 10d and a fifth monitor 10e may monitor at least another one (not shown) of the entities to be picked up 8 at the third pickup zone or location 18n. A fourth authorized entity 12d authorized to pick up the fourth entity to be picked up 8d may park a fourth vehicle 14d at the third pickup zone or location 18n. A fifth authorized entity 12n authorized to pick up the fifth entity to be picked up 8n may reside at the residence 16.

For example, the first facility 6a may be a school. The first, second, and third entities to be picked up 8a-8c may be respective students of the school 6a. The school 6a may have a range of specific grade levels. The school 6a may assign entities to be picked up (e.g., students) 8 of at least a first specific grade level to the first pickup zone or location 18a. The school 6a may assign entities to be picked up (e.g., students) 8 of at least a second specific grade level to the second pickup zone or location 18b. The first entity to be picked up 8a may be a first student of a first specific grade level at the school 6a. The second and third entities to be picked up 8b, 8c may be students of a second specific grade level at the school 6a. The first and second monitors 10a, 10b may be associated with the school 6a (e.g., principal, administrator, teacher, guard, other staff, volunteer parent, etc.). The school 6a may assign the first monitor 10a to the first pickup zone or location 18 or may assign the first monitor 10a to selected entities to be picked up (e.g., students) 8 of at least the first specific grade level. The school 6a may assign the second monitor 10b to the second pickup zone or location 18b or may assign the second monitor 10b to selected entities to be picked up (e.g., students) 8 of at least the second specific grade level. Responsive to such assignment, the first and second monitors 10a, 10b may have respective responsibilities to ensure safety of the respectively assigned entities to be picked up (e.g., students) 8 while the entities to be picked up (e.g., students) 8 wait to be picked up from the school 6a. Such responsibility may include ensuring that each respective assigned entity to be picked up (e.g., student) 8 leaves only with an authorized entity 12 (e.g., at least one of parents, legal guardians, carpool driver, bus drivers, others authorized by respective parents or legal guardians) authorized to pick up the respective entity to be picked up (e.g., student) 8.

Execution of such responsibility poses high risk and stress for each entity involved. For example, the fifth authorized entity 12n may be a first legal guardian of the first entity to be picked up (e.g., a first student) 8a. The first guardian 12n may ask the first authorized entity 12a to pick up the first entity to be picked up (e.g., the first student) 8a on behalf of the first guardian 12n. Without communication from the first guardian 12n, the first monitor 10a may not know that the first authorized entity 12a has authorization from the first guardian 12n to pick up the first entity to be picked up (e.g., the first student) 8a. Such may preclude the first authorized entity 12a from picking up the first entity to be picked up (e.g., the first student) 8a on behalf of the first guardian 12n. Such may increase consumption of temporal resources (e.g., time spent arguing between the first authorized entity 12a and the first monitor 10a, attempting to telephone or email the first guardian 12n by the first monitor 10a, waiting for the first guardian 12n to reply to the telephone call or email to receive confirmation of authorization, etc.). Additionally or alternatively, the first monitor 10a likewise may lack an ability to identify or confirm identity of the first authorized entity 12a or the first guardian 12n (e.g., the first vehicle 12a may have a generic appearance or may be new or a rental, the first monitor 10a may fail to remember a given face or may not have seen a given face before). Such poses security risks (e.g., the first monitor 10a mistaking a random entity for the first authorized entity 12a, the first monitor 10a mistaking a hacked or fraudulent email account of the first guardian 12n for a secure and valid email account of the first guardian 12n). The first monitor 10a may wish to keep contact information of the first monitor 10a private from the first guardian 12n, the first authorized entity 12a, the first entity to be picked up (e.g., the first student) 8a, or other monitors 10. The first guardian 12n or the first authorized entity 12a may wish to keep contact information of the first guardian 12n or the first authorized entity 12a private from the first monitor 10a. Such places security of the first entity to be picked up (e.g., the first student) 8a in conflict with security of at least one of the first monitor 10a, the first guardian 12n, the first authorized entity 12a, or respective personal accounts or devices of the first monitor 10a, the first guardian 12n, and the first authorized entity 12a.

Also for example, the second authorized entity 12b may be a second legal guardian of the second entity to be picked up (e.g., the second student) 8b. An activity (e.g., class, after-school curriculum, detention) may run later than a usual dismissal time. The second guardian 12b may arrive at the second pickup zone or location 18b at the usual dismissal time. Technical problems that are at least similar to those explained above with regard to the first entity to be picked up (e.g., the first student) 8a exist with regard to the second entity to be picked up (e.g., the second student) 8b.

Also, responsive to hot or cold weather, the second guardian 12b may leave an internal combustion engine or other motor of the second vehicle 14b running while the second guardian 12b waits for the second monitor 10b to bring the second entity to be picked up (e.g., the second student 8b) to the second pickup zone or location 18b. Responsive to a duration of such waiting, the second vehicle 14b may run low on fuel. Such may cause the second vehicle 14b to overheat a fuel pump of the second vehicle 14b, thereby irreversibly damaging the second vehicle 14b. Such may also cause the second vehicle 14b pull deposits from a bottom of a fuel tank of the second vehicle 14b to the engine of the second vehicle 14b or run a severely lean fuel mixture that causes engine knock, thereby possibly irreversibly damaging the second vehicle 14b. Such may additionally cause the second vehicle 14b to emit exhaust that may harm nature or an ecosystem of the environment 4.

The third authorized entity 12c may be a third legal guardian of the third entity to be picked up (e.g., a third student) 8c. An activity (e.g., class, after-school curriculum, detention) may conclude earlier than a usual dismissal time. The third guardian 12c may arrive at the second pickup zone or location 18b at the usual dismissal time. Such may expose the second monitor 10b to an extended period of monitoring the third entity to be picked up (e.g., the third student) 8c. Such may expose the third entity to be picked up (e.g., the third student) 8c to an extended waiting period at the second pickup zone or location 18b. Technical problems that are at least similar to those explained above with regard to the second entity to be picked up (e.g., the second student) 8b exist with regard to the third entity to be picked up (e.g., the third student) 8c. Also, responsive to wet weather, water may contact at least one electronic device of the third entity to be picked up (e.g., the third student) 8c or the second monitor 10b, thereby possibly irreversibly damaging the electronic device.

As another example, the second facility 6n may be at least one of another school or alternatively a store, warehouse, or daycare. The fourth entity to be picked up 8d may be a child at another school, daycare or extra curricular activity. The fifth entity 8n to be picked up may alternatively be a package (e.g., a delivery or product) or item. The third monitor 10c may escort the fourth entity to be picked up (e.g., child, package, item) 8d to the third pickup zone or location 18n for the arrival of the fourth authorized entity 12d at the third pickup zone or location 18n. The fifth authorized entity 12n may, for example, be an addressee of the package 8n. In some implementations, the fourth monitor 10d may cause the entities to be picked up (e.g., child, package, item) 8n to approach the third pickup zone or location 18n responsive to arrival of the addressee 12n (e.g., via conveyor, dolly, fork lift, hand carry, pneumatic tube). Each of the third, fourth, fifth, and sixth monitors 10c-10n may have respective responsibilities to ensure safety of the entities to be picked up (e.g., child, package, item) 8d-8n. Such responsibility may include ensuring that the entities to be picked up (e.g., child, package, item) 8d-8n leave only with respective authorized entities 12 (e.g., parents, legal guardians, bus drivers, others authorized by respective parents or legal guardians, addressees, recipients, delivery drivers, others authorized by respective addressees or recipients) respectively authorized to pick up the respective entities to be picked up (e.g., child, package, item) 8d-8n.

Execution of such responsibility poses high risk and stress for each entity involved. For example, the fourth authorized entity 12d may arrive at a different time each day based at least in part on an unknown schedule of the fourth authorized entity 12d. Such may cause an increase of consumption of temporal resources (e.g., time spent watching out for the arrival of the fourth authorized entity 12d, disruption of at least one process in progress at such time of arrival, waiting by the fourth authorized entity 12d for the entity to be picked up (e.g., child) 8d to be escorted to the third pickup zone or location 18n). Technical problems that are at least similar to those explained above with regard to the third entity to be picked up (e.g., third student) 8c exist with regard to pickup of other entities to be picked up (e.g., the child) 8d.

Also for example, the addressee 12n of the an entity to be picked up (e.g., package) 8n may ask the fourth authorized entity 12d to pick up the entity to be picked up (e.g., package) 8n on behalf of the fourth authorized entity 12d. Technical problems that are at least similar to those explained above with regard to coordinating pickup of the entity to be picked up (e.g., package) 8n.

The system 2 that coordinates pickups at least one of addresses or solves at least one of the above explained situations, risks, complications, or problems. For example, FIG. 1 shows the system 2 that coordinates pickups as including a number of monitor devices 20a-20n (collectively 20; only six shown), a number of authorized pickup entity devices 22a-22n (collectively 22; only six shown), at least one communications network 24 (only one shown), at least one time to arrival estimation server 26 (only one shown), at least one coordination server 28 (only one shown), and at least one administration server 30 (only one shown). Each of the time to arrival estimation server 26, coordination server 28, and administration server 30 may have respective databases stored on respective nontransitory computer- or processor-readable media 32a-32n (collectively 32, only three shown).

The term “time to arrival” at least means an amount of time until at least one particular element arrives at one or more locations. The term “estimate” at least means to roughly calculate or judge at least one of a value, number, quantity or extent of at least one element. Accordingly, the time to arrival estimation server 26 is not any modern server (e.g., a generic server). Instead, the time to arrival estimation server 26 is a server that is specifically programmed or structured to at least roughly calculate or judge at least one of a value, number, quantity, or extent of at least an amount of time until at least one element arrives at one or more locations via, for example, at least one portion of at least one algorithm explained herein.

The term “coordinate” at least means to bring different elements of a complex activity or organization into at least one relationship that provides at least one of efficiency or harmony. Accordingly, the coordination server 28 is not any modern server. Instead, the coordination server 28 is a server that is specifically programmed or structured to at least bring different elements of at least one pickup event into at least one relationship that provides at least one of efficiency or harmony via, for example, at least one portion of at least one algorithm explained herein.

The term “administrate” at least means to put at least one operation into effect. Accordingly, the administration server 30 is not any modern server. Instead, the administration server 30 is a server that is specifically programmed or structured to put at least one pickup operation into effect via, for example, at least one portion of at least one algorithm explained herein.

The monitor devices 20 may, for example, take the form of any variety of communications enabled devices, including wireless communications devices such as tablet computers, smartphones, netbook computers with wireless modems. The authorized pickup entity devices 22 may, for example, take the form of any variety of communications enabled devices, including wireless communications devices such as tablet computers, smartphones, netbook computers with wireless modems, and wireless enabled headunits of vehicles. The monitor devices 20 and/or the authorized pickup entity devices 22 may, for example, each respectively store one or more unique identifiers, for example a Mobile Identification Number (MIN), Mobile Subscription Identification Number (MSIN), Mobile Station Identifier (MSID), International Mobile Subscriber Identity (IMSI), or International Mobile Station Equipment Identity (IMEI). Such can be stored in the device in a non-removable memory or in a removable memory (e.g., Subscriber Identity Module (SIM) card).

Each of the monitor devices 20, authorized pickup entity devices 22, time to arrival estimation server 26, coordination server 28, or administration server 30 may communicably couple to the communications network 24 via at least one respective wired connection (e.g., electrically conductive wires, optical fiber) or at least one respective wireless connection (e.g., radio, WI-FI® radio, Bluetooth® radio, cellular radio, optical emitter and sensor pair such as an infrared emitter and sensor pair). The coordination server 28 may communicably couple to at least one of the monitor devices 20, authorized pickup entity devices 22, time to arrival estimation server 26, or administration server 30 via the communications network 24.

The coordination server 28 may logically associate in the database stored on one of the nontransitory processor-readable media 32b at least one of the monitor devices 20 with at least one of the facilities 6. Additionally or alternatively, the coordination server 28 may logically associate in the database stored on the nontransitory processor-readable media 32b at least one of the monitor devices 20 with at least one of the pickup zones or locations 18. Additionally or alternatively, the coordination server 28 may logically associate in the database stored on the nontransitory processor-readable media 32b at least one of the monitor devices 20 with at least one of the monitors 10, for example logically associating a unique identifier of a mobile communications device (e.g., smartphone) with a name or identifier that uniquely identifies the monitor 10. Additionally or alternatively, the administration server 30 may logically associate in the database stored on one of the nontransitory processor-readable media 32n at least one of the monitor devices 20 with at least one of the facilities 6. Additionally or alternatively, the administration server 30 may logically associate in the database stored on the nontransitory processor-readable media 32n at least one of the monitor devices 20 with at least one of the pickup zones or locations 18. Additionally or alternatively, the administration server 30 may logically associate in the database stored on the nontransitory processor-readable media 32n at least one of the monitor devices 20 with at least one of the monitors 10, for example logically associating a unique identifier of a mobile communications device (e.g., smartphone) with a name or identifier that uniquely identifies the monitor 10. For example, each of the monitor devices 20, facilities 6, pickup zones or locations 18, or monitors 10 may have at least one respective unique identifier (e.g., globally unique, locally unique to at least one of the facilities 6).

The coordination server 28 may logically associate in the database stored on one of the nontransitory processor-readable media 32b at least one of the authorized pickup entity devices 22 with at least one of the authorized entities 12, for example logically associating a unique identifier of a mobile communications device (e.g., smartphone) with a name or identifier that uniquely identifies the authorized entities 12. Additionally or alternatively, the administration server 30 may logically associate in the database stored on the nontransitory processor-readable media 32n at least one of the authorized pickup entity devices 22 with at least one of the authorized entities 12, for example logically associating a unique identifier of a mobile communications device (e.g., smartphone) with a name or identifier that uniquely identifies the authorized entities 12. For example, each of the authorized pickup entity devices 22, or authorized entities 12 may have at least one respective unique identifier (e.g., globally unique, locally unique to at least one of the facilities 6).

The coordination server 28 may logically associate in the database stored on the nontransitory processor-readable media 32b at least one of the entities to be picked up 8 with at least one of the facilities 6, specific grade levels, monitors 10, authorized entities 12, pickup zones or locations 18, monitor devices 20, or authorized pickup entity devices 22. Additionally or alternatively, the administration server 30 may logically associate in the database stored on the nontransitory processor-readable media 32n at least one of the entities to be picked up 8 with at least one of the facilities 6, specific grade levels, monitors 10, authorized entities 12, pickup zones or locations 18, monitor devices 20, or authorized pickup entity devices 22. For example, each of the entities to be picked up 8 or specific grade levels may have at least one respective unique identifier (e.g., globally unique with regard to at least entities to be picked up 8, locally unique to at least one of the facilities 6 with regard to at least entities to be picked up 8).

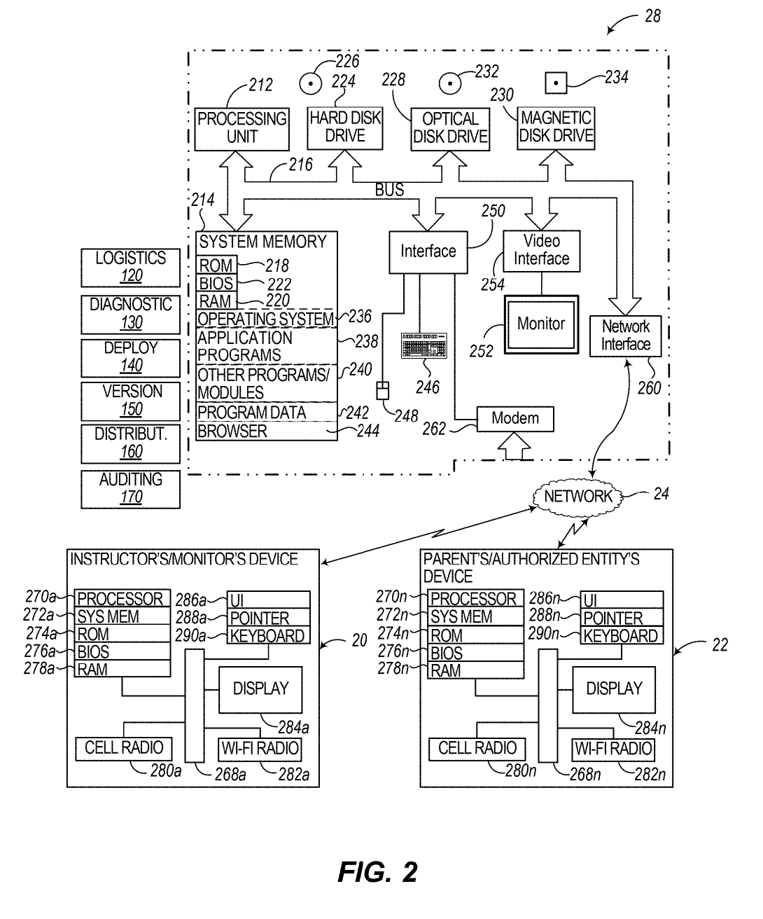

FIG. 2 and the following discussion provide a brief, general description of an example suitable computing environment of the system 2 of FIG. 1. The example suitable computing environment includes the coordination server 28. The coordination server 28 incorporates an Inventory Logistics System 120, a Diagnostics System 130, a Deployment and Positioning System 140, an Instruction Versioning Approval System 150, an Instruction Content Distribution System 160, and an Auditing System 170. The coordination server 28 communicably couples to at least one communications network 24. The communications network 24 communicably couples the coordination server 28 to example ones of the monitor devices 20 and the authorized pickup entity devices 22.

Although not required, several implementations are described in the general context of computer-executable instructions, such as program application modules, objects, or macros being executed by a computer. Those skilled in the relevant art will appreciate that the illustrated embodiments as well as other embodiments can be practiced with other computer system configurations, including hand-held devices, multiprocessor systems, microprocessor-based or programmable consumer electronics, personal computers (“PCs”), network PCs, mini computers, mainframe computers, and the like, specifically programmed or configured to operate according to at least one algorithm explained herein. The embodiments can be practiced in distributed computing environments where tasks or modules are performed by remote processing devices, which are linked through the communications network 24. In a distributed computing environment, program modules may be located in both local and remote memory storage devices. For example, anything explained herein with regard to at least one of the monitor devices 20, authorized pickup entity devices 22, time to arrival estimation server 26, coordination server 28, or administration server 30 may additionally or alternatively be at least one of performed by or located in at least one component of at least another one of the monitor devices 20, authorized pickup entity devices 22, time to arrival estimation server 26, coordination server 28, or administration server 30.

The coordination server 28 may take the form of a mainframe or mini-computer that includes a processing unit 212, an at least partially nontransitory system memory 214 and a system bus 216 that couples various system components including the system memory 214 to the processing unit 212. The coordination server 28 will at times be referred to in the singular herein, but this is not intended to limit the embodiments to a single coordination server since in typical embodiments, there will be more than one coordination server 28 or other device involved. The computing environment may employ other computers, such as personal computers, where the size or scale of the system allows, specifically programmed or configured to operate according to at least one algorithm explained herein.

The processing unit 212 may be any logic processing unit, such as one or more central processing units (CPUs), digital signal processors (DSPs), application-specific integrated circuits (ASICs), etc., specifically programmed or configured to operate according to at least one algorithm explained herein. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the back-end system 28, such as during start-up.

The coordination server 28 also includes a hard disk drive 224 for reading from and writing to a hard disk 226, and an optical disk drive 228 and a magnetic disk drive 230 for reading from and writing to removable optical disks 232 and magnetic disks 234, respectively. The optical disk 232 can be a CD-ROM, while the magnetic disk 234 can be a magnetic floppy disk or diskette. The hard disk drive 224, optical disk drive 228 and magnetic disk drive 230 communicate with the processing unit 212 via the system bus 216. The hard disk drive 224, optical disk drive 228 and magnetic disk drive 230 may include interfaces or controllers (not shown) coupled between such drives and the system bus 216. The drives 224, 228 and 230, and their associated computer-readable media 226, 232, 234, provide nonvolatile storage of computer readable instructions, data structures, program modules and other data for the back-end system 28. Although the depicted back-end system 28 employs hard disk 224, optical disk 228, and magnetic disk 230, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, solid state drives, etc.

Program modules can be stored in the system memory 214, such as an operating system 236, one or more application programs 238, other programs or modules 240 and program data 242. The system memory 214 may also include communications programs for example a Web client or browser 244 for permitting the back-end system 28 to access and exchange data with sources such as Web sites of the Internet, corporate intranets, or other networks as described below, as well as other server applications on server computing systems such as those discussed further below. The browser 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from America Online® and Microsoft® of Redmond, Wash.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230. A system operator can enter commands and information into the coordination server 28 through input devices such as a touch screen or keyboard 246 and/or a pointing device such as a mouse 248. Other optional input devices can include a microphone, joystick, game pad, tablet, scanner, etc. These and other input devices are communicably coupled to the processing unit 212 through an interface 250 such as a universal serial bus (“USB”) interface that couples to the system bus 216, although other interfaces such as a parallel port, a game port or a wireless interface or serial port can be used. A monitor 252 or other display device is coupled to the system bus 216 via a video interface 254, such as a video adapter. The coordination server 28 can include other output devices, such as speakers, printers, etc.

At least one of the monitor devices 20 or authorized pickup entity devices 22 may be any logic processing unit, such as one or more central processing units (CPUs), digital signal processors (DSPs), application-specific integrated circuits (ASICs), etc., specifically programmed or configured to operate according to at least one algorithm explained herein. The system bus 268 can employ any known bus structures or architectures, including a memory bus with memory controller, a peripheral bus, and a local bus. The system memory 272 includes read-only memory (“ROM”) 274 and random access memory (“RAM”) 278. A basic input/output system (“BIOS”) 276, which can form part of the ROM 274, contains basic routines that help transfer information between elements within the portable device 110, such as during start-up.

At least one of the monitor devices 20 or authorized pickup entity devices 22 also respectively include one or more storage drives 280a-280n (collectively 280; only two shown). The one or more storage drives 280 may contain data indicative of one or more checklists and/or instruction sets. The storage drives 280 can include any type, number, or combination, of non-volatile, nontransitory storage media including magnetic storage media, optical storage media, electromagnetic storage media, molecular or atomic storage media, quantum storage media, or combinations thereof. At least one of the monitor devices 20 or authorized pickup entity devices 22 also respectively include one or more processors 270a-270n (collectively 270; only two shown). The storage drive(s) 280 communicate with the processor 270 via the system bus 268. At least one of the monitor devices 20 or authorized pickup entity devices 22 also respectively include one or more system buses 268a-268n (collectively 268; only two shown). The one or more storage drives 280 may include interfaces or controllers (not shown) coupled between such drives and the system bus 268, as is known by those skilled in the relevant art. The one or more storage drives 280, provide nonvolatile storage of computer readable instructions, data structures, program modules and other data for at least one of the monitor devices 20 or authorized pickup entity devices 22.

At least one of the monitor devices 20 or authorized pickup entity devices 22 also respectively include one or more system memory 272a-272n (collectively 272; only two shown). Program modules can be stored in the system memory 272, such as an operating system, one or more application programs, other programs or modules and program data. The system memory 272 may also include communications programs for example a Web client or browser for permitting at least one of the monitor devices 20 or authorized pickup entity devices 22 to access and exchange data with sources such as Web sites of the Internet, corporate intranets, or other networks as described below, as well as other server applications on server computing systems such as those discussed further below. The browser in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Google®, Apple®, America Online® and Microsoft® of Redmond, Wash.

At least one of the monitor devices 20 or authorized pickup entity devices 22 also respectively include one or more communications interfaces 282a-282n (collectively 282; only two shown). The communications interfaces 282 communicably coupled to the system bus 268. The one or more communications interfaces 282 can include one or more Bluetooth® interfaces, one or more near field communications (“NFC”) interfaces, one or more cellular communications interfaces, one or more radio frequency identification (“RFID”) interfaces, or any other RF or microwave interface capable of supporting a data exchange with an external device such as at least one of the authorized pickup entity devices 22a, 22c, 22d, or 22e of the vehicles 14. The one or more communications interfaces 282 can also include one or more tethered communications interfaces such as an IEEE 1394 (“Firewire”) interface, a USB interface, or similar standard or proprietary interface capable of supporting a data exchange with an external device such as at least one of the authorized pickup entity devices 22a, 22c, 22d, or 22e of the vehicles 14. In at least some implementations, any number of communications interfaces 282 may be in simultaneous use by at least one of the monitor devices 20 or authorized pickup entity devices 22. For example, a given one of the authorized pickup entity devices 22a, 22c, 22d, or 22e (e.g., head units) of the vehicles 14 may communicate vehicle identification and position data to at least another one of the authorized pickup entity devices 22 via, for example, a wireless IEEE 802.11 interface of the communications interfaces 282. At the same time, at least one of the monitor devices 20 or authorized pickup entity devices 22 also respectively include one or more cellular communications interfaces 280a-280n (collectively 280; only two shown). The monitor devices 20 or authorized pickup entity devices 22 may communicate the information to the coordination server 28 via a global system for mobile devices (“GSM”) by cellular communications interface 280.

At least one of the monitor devices 20 or authorized pickup entity devices 22 also respectively include one or more user interfaces 286a-286n (collectively 286; only two shown), touch screens or keyboards 290a-290n (collectively 290; only two shown), or pointers (e.g., mice) 288a-288n (collectively 288; only two shown). A system operator such as a monitor 10 or authorized entity 12 can enter commands and information into the respective monitor devices 20 or authorized pickup entity devices 22 by providing input to a user interface 286 through respective input devices such as the touch screens or keyboards 290 and/or the pointers 288. Other optional input devices can include a microphone, joystick, game pad, tablet, scanner, etc. These and other input devices are communicably coupled to the processor 270 through an interface such as a universal serial bus (“USB”) interface that couples to the system bus 268, although other interfaces such as a parallel port, a game port or a wireless interface or serial port can be used. At least one of the monitor devices 20 or authorized pickup entity devices 22 also respectively include one or more displays 284a-284n (collectively 284; only two shown). The display 284 is coupled to the system bus 268. The monitor devices 20 or authorized pickup entity devices 22 can respectively include other optional output devices, such as speakers, printers, etc.

### Operation

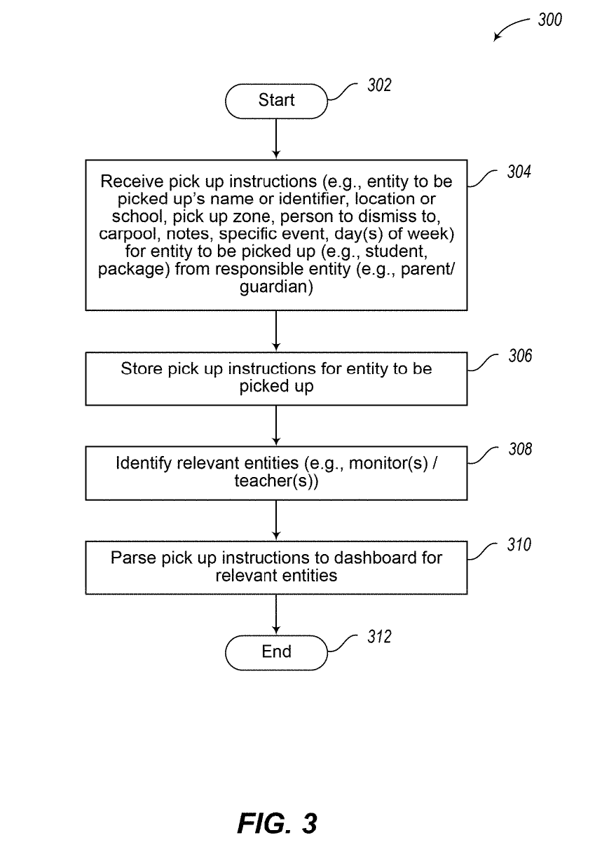

FIG. 3 shows high level flow diagram of a coordination of pickups method 300 in which the coordination server 28 coordinates pickups, according to at least one illustrated implementation.

In the method 300, the coordination server of FIG. 1 receives pickup instructions from at least one responsible entity for at least one entity to be picked up, stores the pickup instructions for the entity to be picked up to at least one nontransitory computer-readable medium, identifies at least one relevant entity, and the parses the pickup instructions to at least one dashboard for the relevant entities.

The method 300 starts at 302. For example, the method 300 may start at 302 responsive to at least one trigger. The trigger may include powering on one or more components of the system (e.g., at least one of the coordination server 28, monitor devices 20, authorized pickup entity devices 22, or monitor administration server 30) or invocation by at calling routine, function, program or subprogram. Additionally or alternatively, the trigger may include at least one user input (e.g., entering pickup instructions via one of the authorized pickup entity devices 22) or receipt of communications.

Responsive to the start 302 of the method 300, the coordination server 28 may receive pickup instructions at 304 from a given one of the authorized entities 12. The pickup instructions may include at least one identifier of a given one of the entities to be picked up 8 (e.g., legal name, student identification number, tracking number), facilities 6, or pickup zones or locations 18. Additionally or alternatively, the pickup instructions may include at least one identifier of another given one of the authorized entities or a carpool indicator (e.g., whether the given one of the entities to be picked up 8 will be picked up with at least another given one of the entities to be picked up 8, a name or identifier of the other given one of the entities to be picked up 8, etc.). Additionally or alternatively, the pickup instructions may include at least one of custom notes (e.g., whether the given of the authorized entities 12 will drive a different one of the vehicles 19 than usual, whether the given one of the entities to be picked up 8 requires special handling, other instructions for a corresponding one of the monitors 10), specific event information (e.g., class or after-school activity dismissal, conclusion of processing the given one of the entities to be picked up 8, a particular time), or a day of a week (e.g., the instructions apply to a single Monday, each Monday, every other Monday, the first Monday of every month).

A given one of the authorized pickup entity devices 22 that is logically associated with the given one of the authorized entities 12 may push the pickup instructions to the coordination server 28. Accordingly, at least because the coordination server 28 accepts pushed pickup instructions, the coordination server 28 does not need to repeatedly request the pickup instructions, thereby reducing processing resource consumption (e.g., power, processing, bandwidth) and communication resource consumption (e.g., data usage, bandwidth). Additionally or alternatively, the given one of the authorized pickup entity devices 22 may provide the pickup instructions responsive to a pull by the coordination server 28. Accordingly, at least because the coordination server 28 pulls the pickup instructions, the coordination server 28 reduces a likelihood of receiving the pickup instructions while overloaded with other tasks that may prevent the coordination server 28 from accepting the pickup instructions.

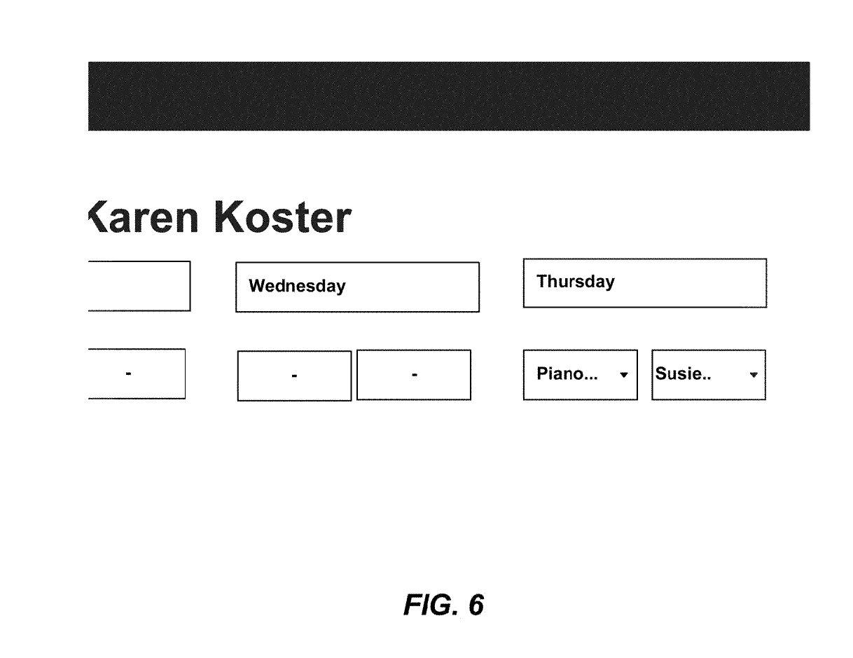

For example, the coordination server 28 may include or communicably couple with at least one application server or Web server. The application or Web server may provide authorized pickup entity content (e.g., at least one authorized pickup entity scheduler) to the given one of the authorized pickup entity devices 22 via the communications network 24. The authorized pickup entity content may activate at least one element (e.g., a browser that transforms the authorized pickup entity content to interactive authorized pickup entity content such as an interactive authorized pickup entity scheduler responsive to the specific programming of the authorized pickup entity content) of the given one of the authorized pickup entity devices 22 to cause at least one authorized pickup entity graphical user interface to display on the given one of the authorized pickup entity devices 22. The authorized pickup entity graphical user interface may permit entry of at least one portion of the instructions via at least one interface of the given one of the authorized pickup entity devices 22. For example, the authorized pickup entity graphical user interface may include at least one selectable or editable text box, check box, radio button, drop down list, etc. The authorized pickup entity graphical user interface may permit submission of the pickup instructions. For example, the authorized pickup entity content may have specific programming that causes the element to transform data input via the authorized pickup entity graphical user interface to pickup instructions that have at least one of the above-explained formats. Such may involve comparing at least one piece of input data to at least one reference in at least one memory to populate or change at least one portion of the input data. Accordingly, at least because the coordination server 28 provides the authorized pickup entity content to the given one of the authorized pickup entity devices 22, the coordination server 28 permits the given one of the authorized pickup entity devices 22 to have an increase in freedom with regard to storage allocation. For example, FIG. 6 shows a screen shot of an example instance of the authorized pickup entity graphical user interface that the element of the given one of the authorized pickup entity devices 22 may cause to display on the given one of the authorized pickup entity devices 22.

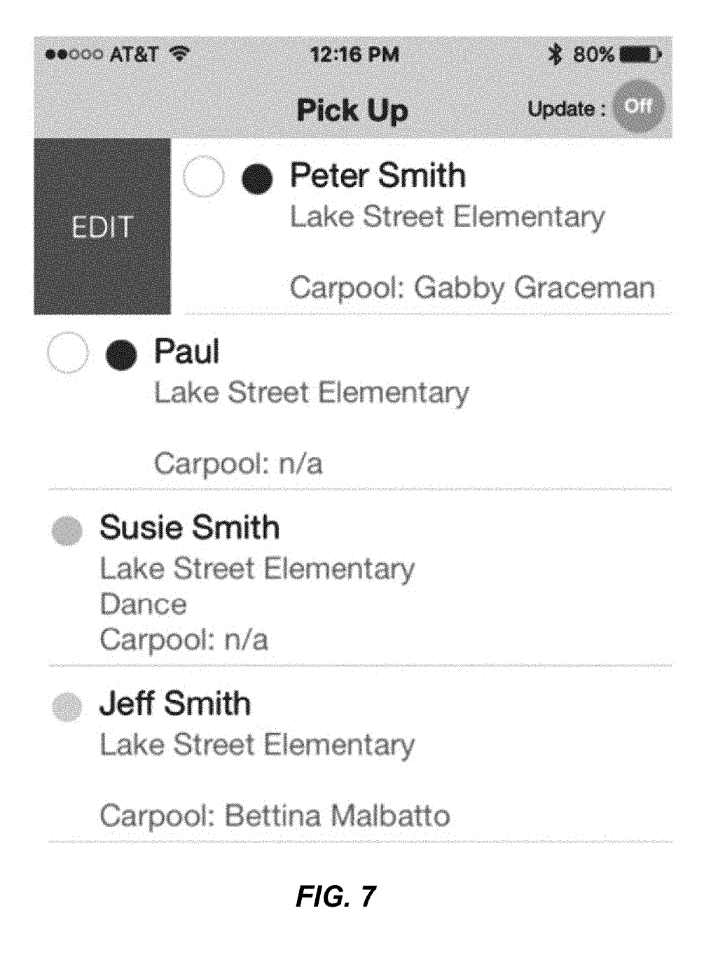

Additionally or alternatively, the given one of the authorized pickup entity devices 22 may store at least one authorized pickup entity application. The coordination server 28 may deploy at least one update to the authorized pickup entity application via the communications network 24. For example, the coordination server 28 may cause the authorized pickup entity application to transform the above-explained authorized pickup entity content to interactive authorized pickup entity content such as an interactive authorized pickup entity scheduler. Responsive to executing the authorized pickup entity application, the given one of the authorized pickup entity devices 22 may display the above-explained authorized pickup entity graphical user interface that permits entry of at least one portion of the instructions via at least one interface of the given one of the authorized pickup entity devices 22. The authorized pickup entity graphical user interface may permit at least one submission of the pickup instructions as explained above. The given one of the authorized pickup entity devices 22 may store the authorized pickup entity application in local nontransitory computer-readable memory, thereby permitting use of the authorized pickup entity scheduler when the given one of the authorized pickup entity devices 22 communicably couples to the coordination server 28 and when the given one of the authorized pickup entity devices 22 fails to communicably couple to the coordination server 28 (e.g., dead zone, airplane mode, peak rates). The authorized pickup entity application may cause the given one of the authorized pickup entity devices 22 to store the pickup instructions as at least one pickup instructions object. Responsive to detecting a lack of connection to the communications network 24, the authorized pickup entity application may cause the given one of the authorized pickup entity devices 22 to store the pickup instructions object to local nontransitory computer-readable memory. The authorized pickup entity application may cause the given one of the authorized pickup entity device authorized pickup entity devices 22 to communicably couple to the coordination server 28 responsive to detecting connection to the communications network 24. Responsive to such communicable coupling, the authorized pickup entity application may cause the given one of the authorized pickup entity devices 22 to submit at least one of the pickup instructions or pickup instructions object to the coordination server 28 via the communications network 24. At least because the coordination server 28 enables the given one of the authorized pickup entity devices 22 to use the authorized pickup entity scheduler via the authorized pickup entity application, the coordination server 28 permits conservation of communication resources (e.g., data usage, bandwidth) until the given one of the authorized pickup entity devices 22 has an ability to communicably couple to the coordination server 28 via a faster or higher bandwidth connection (e.g., IEEE 802.11x data speed or bandwidth as compared to those of cellular data communication). For example, FIG. 7 shows a screen shot of an example instance of the authorized pickup entity graphical user interface that the authorized pickup entity application may cause to display on the given one of the authorized pickup entity devices 22.

Responsive to receiving the pickup instructions, the coordination server 28 may store the pickup instructions for the given one of the entities to be picked up 8 in at least one nontransitory computer-readable medium at 306. For example, the coordination server 28 may determine whether the received pickup instructions lack at least one piece of information explained above. Responsive to determining that the received pickup instructions lack such piece of information, the coordination server 28 may query at least one of the databases stored on nontransitory processor-readable media 32 for such piece of information. At least one of the coordination server 28 or the administration server 30 may logically associate in at least one of the databases stored on nontransitory processor-readable media 32 such piece of information with at least one entity identified by the pickup instructions (e.g., the given one of the entities 8 to be picked up, the given one of the authorized entities 12). Responsive to obtaining such piece of information, the coordination server 28 may populate the received pickup instructions with each obtained piece of information and store the completed pickup instructions in the database of the nontransitory computer-readable medium 32. Accordingly, the coordination server 28 reduces an amount of information that the given one of the authorized pickup entity devices 22 must transmit via the communications network 24, thereby improving consumption of communication resources.

The coordination server 28 may identify at least one relevant entity at 308. For example, the coordination server 28 may identify each of the monitors 10 that is logically associated with the given one of the entities to be picked up 8. For example, the coordination server 28 may identify each given one of the monitors 10 that is logically associated with a given one of the grade levels or pickup zones or locations 18 of the given one of the entities to be picked up 8. Accordingly, the coordination server 28 permits the given one of the monitors 10 to login to any of a plurality of the monitor devices 20. Additionally or alternatively, the coordination server 28 may identify each given one of the monitor devices 20 that is logically associated with the given one of the entities to be picked up 8. For example, the coordination server 28 may identify each given one of the monitor devices 20 that is logically associated with a given one of the grade levels or pickup zones or locations 18 of the given one of the entities to be picked up 8. Accordingly, the coordination server 28 permits any of the monitors 10 to utilize the given one of the monitor devices 20.

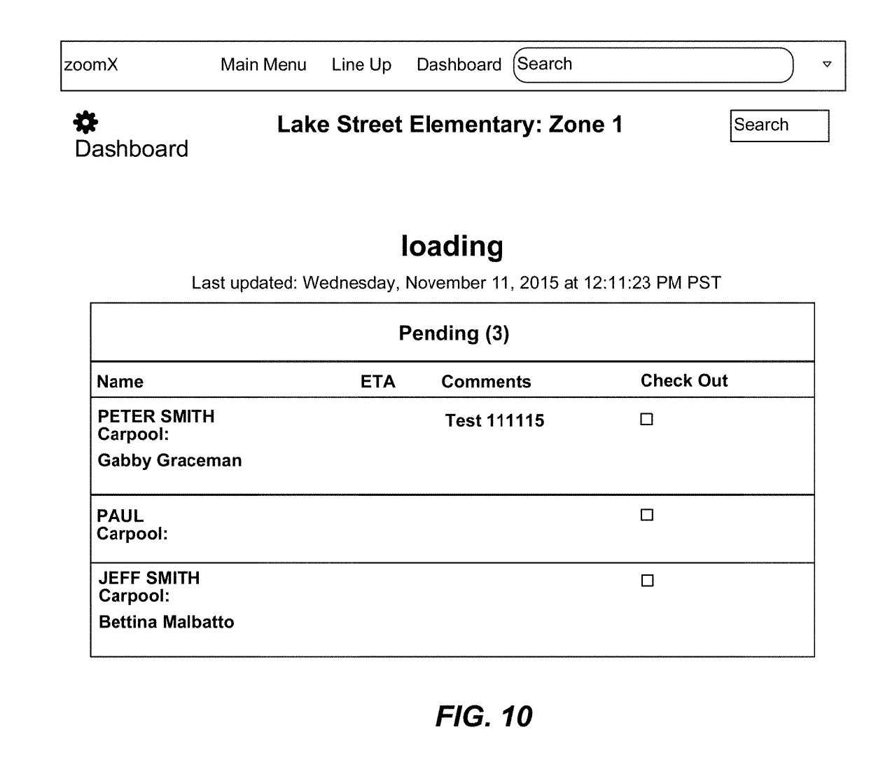

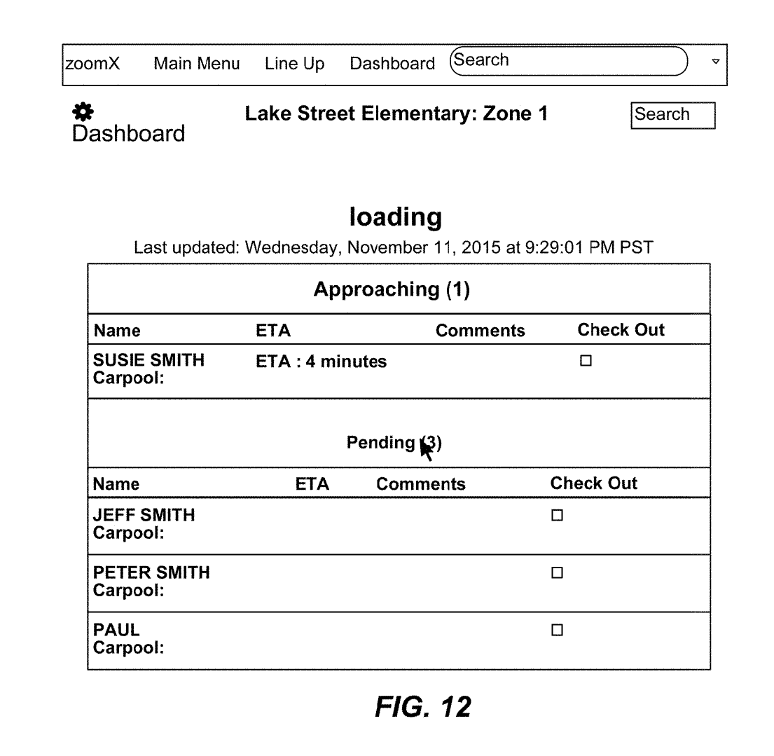

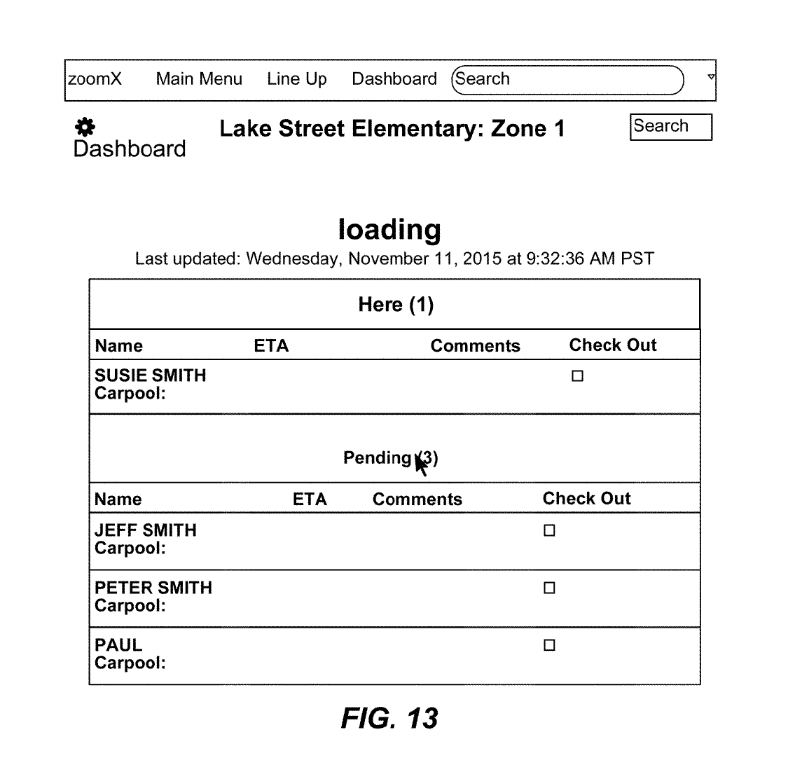

Responsive to identifying the relevant entity, the coordination server 28 may parse the pickup instructions to at least one monitor dashboard for the relevant entity at 310. The monitor dashboard may include at least one list of entities to be picked up 8 (FIGS. 10-14). The list may include each of the entities to be picked up 8 that is logically associated with at least one of the facilities 6, pickup zones or locations 18 of such at least one of the facilities 6, rooms (e.g., classroom, storage room) of such at least one of the facilities 6, or given one of the monitors 10. For each listed one of the entities to be picked up 8, the monitor dashboard may include at least one indicator of whether the listed one of the entities to be picked up 8 is in a carpool with another one of the entities to be picked up 8 (e.g., an identifier indicative of the other one of the entities to be picked up 8), the custom notes, the specific event information, or at least one target ready indicator that indicates whether the listed one of the entities to be picked up 8 is presently ready to be picked up (e.g., whether a present time of day is later than a dismissal time of a final activity at such at least one of the facilities 6 for the given one of the entities to be picked up 8, whether processing or handling of the given one of the entities to be picked up 8 is complete). For example, the coordination server 28 may push the parsed pickup instructions to the given one of the monitor devices 20. Accordingly, at least because the coordination server 28 pushes the parsed pickup instructions, the given one of the monitor devices 20 does not need to repeatedly request the parsed pickup instructions, thereby reducing processing and communication resource consumption. Additionally or alternatively, the coordination server 28 may provide the parsed pickup instructions responsive to at least one parsed pickup instruction pull by the given one of the monitor devices 20. Accordingly, at least because the coordination server 28 provides the parsed pickup instructions responsive to a parsed pickup instruction pull from the given one of the monitor devices 20, the coordination server 28 reduces a likelihood of the given one of the monitor devices 20 receiving the parsed pickup instructions while overloaded with other tasks that may prevent the given one of the monitor devices 20 from accepting the parsed pickup instructions.

For example, the coordination server 28 may include or communicably couple with the application server or Web server as explained above. The application or Web server may provide monitor content (e.g., at least one piece of the parsed pickup instructions) to the given one of the monitor devices 20 via the communications network 24. The monitor content may activate at least one element (e.g., a browser that transforms the monitor content to interactive monitor content such as an interactive monitor dashboard responsive to the specific programming of the monitor content) of the given one of the monitor devices 20 to cause at least one monitor graphical user interface to display on the given one of the monitor devices 20. Accordingly, at least because the coordination server 28 provides the monitor content to the given one of the monitor devices 20, the coordination server 28 permits the given one of the monitor devices 20 to have an increase in freedom with regard to storage allocation. For example, FIG. 10 shows a screen shot of an example instance of the monitor graphical user interface that the element of the given one of the monitor devices 20 may cause to display on the given one of the monitor devices 20.

Additionally or alternatively, the given one of the monitor devices 20 may store at least one monitor application. The coordination server 28 may deploy at least one update to the monitor application via the communications network 24. For example, the coordination server 28 may cause the monitor application to transform the above-explained monitor content to interactive monitor content such as an interactive monitor dashboard. Responsive to executing the monitor application, the given one of the monitor devices 20 may display the above-explained monitor graphical user interface. The coordination server 28 may provide at least one piece of the parsed pickup instructions to the given one of the monitor devices 20 via the communications network 24. The at least one piece of the parsed pickup instructions may cause the given one of the monitor devices 20 to populate the monitor graphical user interface. The monitor application may cause the given one of the monitor devices 20 to populate the monitor graphical user interface with monitor content or interactive monitor content. At least because the coordination server 28 enables the given one of the monitor devices 20 to use the monitor dashboard via the monitor application, the coordination server 28 permits communicating the parsed pickup instructions to the given one of the monitor devices 20 without data indicative of graphical displays, thereby conserving communication resources. For example, the monitor application may cause the given one of the monitor devices 20 to display the example instance of the monitor graphical user interface shown in the screen shot of FIG. 10.

The method 300 may end at 312. In some implementations, the method 300 may operate continuously, or may operate as a plurality of threads of a multi-threaded process operating on suitable processor(s) (e.g., multi-core processor(s)).

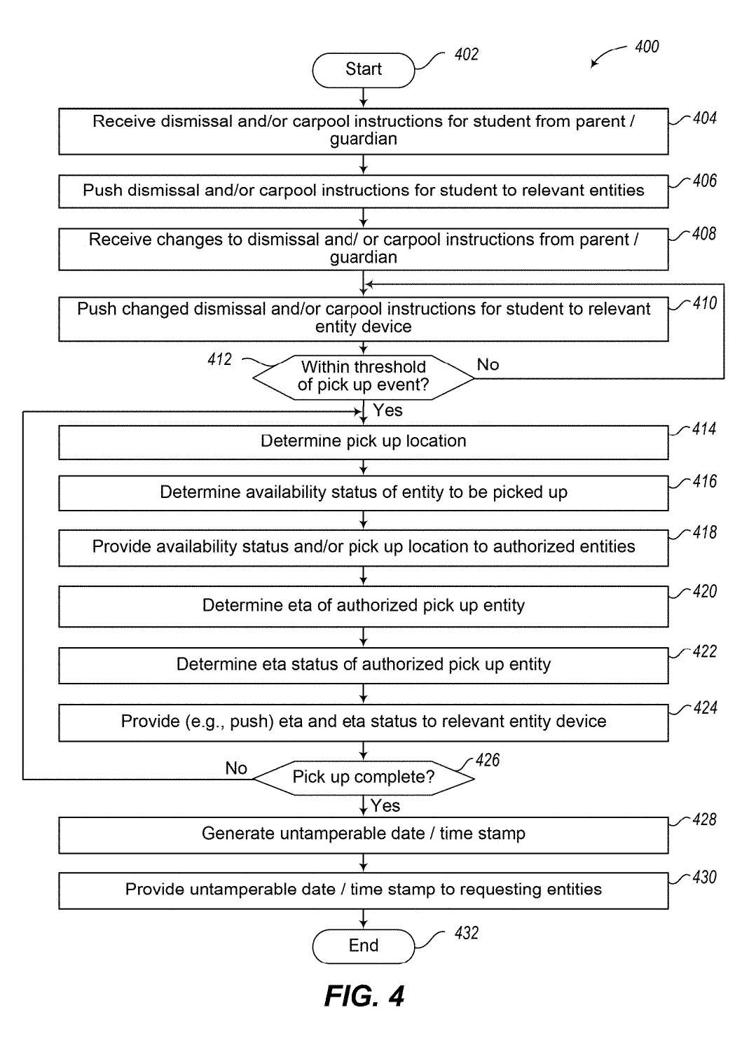

Additionally or alternatively to the method 300 or at least one of acts 302-312, the coordination server 28 may provide updated information to at least one of the given one of the monitor devices 20 or authorized pickup entity devices 22. For example, as illustrated in FIG. 4.

FIG. 4 is a high level flow diagram of a coordination of pickups method 400 executable by coordination server of FIG. 1, according to at least one illustrated implementation.

In the method 400, the coordination server of FIG. 1 permits interaction between the monitor devices and authorized pickup entity devices while maintaining privacy of entities logically associated with such devices and while addressing a plurality of technical problems that one of ordinary skill in the art may face when implementing the system of FIG. 1.

The method 400 starts at 402. For example, the method 400 may start at 402 responsive to at least one trigger. For example, the method 400 may start at 402 responsive to at least one trigger as explained above with regard to the method 300.

Responsive to the start 402 of the method 400, the coordination server 28 may receive at least one of dismissal or carpool instructions at 404 from the given one of the authorized entities 12 with regard to the given one of the entities to be picked up 8. For example, the coordination server 28 may receive the dismissal or carpool instructions at 404 from the given one of the authorized entities 12 authorized to pick up the given one of the entities to be picked up 8 as explained above with regard to the pickup instructions of the method 300.

Responsive to receiving the dismissal or carpool instructions, the coordination server 28 may push the dismissal or carpool instructions to relevant entities at 406. For example, the coordination server 28 may push at least one of the dismissal or carpool instructions or one or more of parsed dismissal or carpool instructions to the given one of the monitor devices 20 as explained above with regard to the parsed pickup instructions of the method 300 (e.g., as explained above with regard to at least one of acts 306-310 of the method 300).

The coordination server 28 may receive changes to at least one of the dismissal or carpool instructions at 408 from the given one of the authorized entities 12. For example, the coordination server 28 may receive at least one of edited or replacement dismissal or carpool instructions from the given one of the authorized entities 12 as explained above with regard to the dismissal or carpool instructions of 404. The received edited or replacement dismissal or carpool instructions may include only data indicative of at least one difference between the dismissal or carpool instructions and the edited or replacement dismissal or carpool instructions. Accordingly, the coordination server 28 permits reducing processing or communication resource consumption.

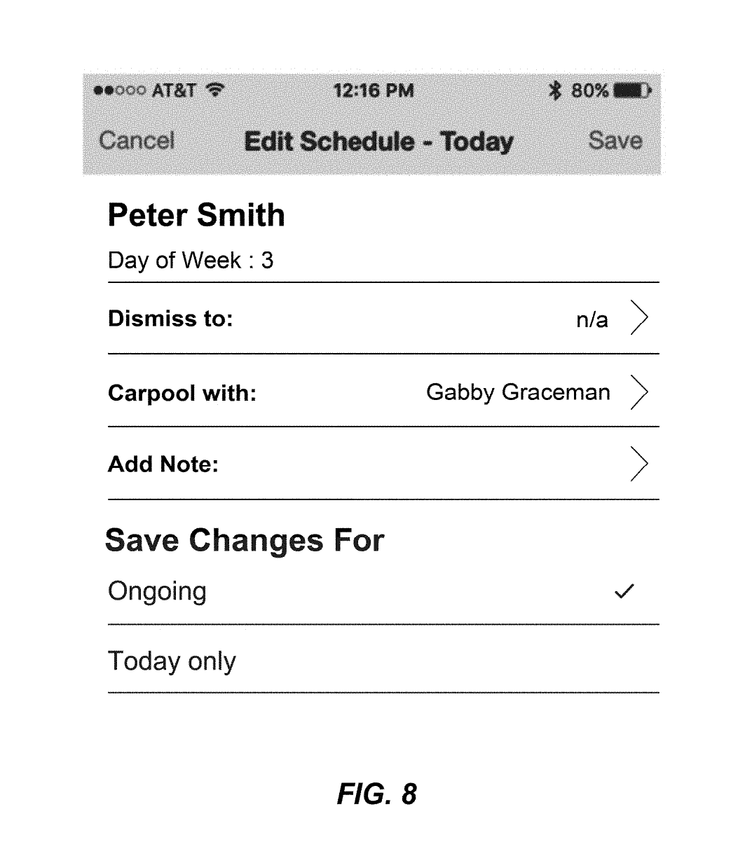

For example, the above-explained authorized pickup entity content or authorized pickup entity application may cause the authorized pickup entity graphical user interface to display at least one selectable instruction edit or replacement icon. The authorized pickup entity content or authorized pickup entity application may cause the authorized pickup entity graphical user interface to permit editing or replacing the dismissal or carpool instructions responsive to the given one of the authorized entities 12 selecting the selectable instruction edit or replacement icon. The authorized pickup entity content or authorized pickup entity application may cause the authorized pickup entity graphical user interface to display at least one selectable instruction submit or save icon. The authorized pickup entity content or authorized pickup entity application may cause the given one of the authorized pickup entity devices 22 to create at least one persistence indicator that indicates whether the edited or replacement dismissal or carpool instructions are permanent (e.g., the edited or replacement dismissal or carpool instructions persist until a subsequent edit, replacement, or deletion) or temporary (e.g., the edited or replacement dismissal or carpool instructions persist for a defined number of occurrences or a defined amount of time or number of days while the defined number is predefined or user selected or input). The authorized pickup entity content or authorized pickup entity application may cause the given one of the authorized pickup entity devices 22 to provide the persistence indicator to the coordination server 28 with the edited or replacement dismissal or carpool instructions. At least because the coordination server 28 accepts the persistence indicator, the coordination server 28 does not require a subsequent edit or replacement to revert to the dismissal or carpool instructions when temporary edited or replacement dismissal or carpool instructions expire, thereby reducing processing or communication consumption. For example, FIG. 8 shows a screen shot of an example instance of the authorized pickup entity graphical user interface that may permit editing or replacing the dismissal or carpool instructions.

Responsive to receiving the edited or replacement dismissal or carpool instructions, the coordination server 28 may push the edited or replacement dismissal or carpool instructions to the relevant entities at 410 as explained above with regard to the dismissal or carpool instructions at 406. The coordination server 28 may push the persistence indicator to the relevant entities with the edited or replacement dismissal or carpool instructions. Accordingly, the coordination server 28 does not require again pushing the dismissal or carpool instructions responsive to expiration of temporary edited or replacement dismissal or carpool instructions, thereby reducing processing or communication resource consumption. Additionally or alternatively, the coordination server 28 may push the dismissal or carpool instructions to the relevant entities responsive to expiration of temporary edited or replacement dismissal or carpool instructions, thereby reducing storage or processing resource consumption of the given one of the monitor devices 20.

The coordination server 28 may determine whether a present time of day is within at least one pickup event threshold of at least one pickup event at 412. The coordination server may calculate at least one amount of time between the present time of day and at least one scheduled time of the pickup event. The coordination server may compare the calculated amount of time to the pickup event threshold. The pickup event threshold may be a defined amount of time prior to the scheduled time of the pickup event. For example, the scheduled time of the pickup event may be at least one time of day selected or defined by the given one of the authorized entities 12. At least one of the dismissal or carpool instructions or the edited or replacement dismissal or carpool instructions may indicate the scheduled time of the pickup event. Additionally or alternatively, the scheduled time of the pickup event may be at least one time of day defined by conclusion of at least one scheduled event of the given one of the entities 8 to be picked up (e.g., conclusion of at least one class, after-school activity, or processing event such as at least one packaging activity, delivery, manufacture activity). The coordination server 28 may repeat such determination at 412 until the coordination server 28 determines that, yes, the present time of day falls within the pickup event threshold of the pickup event. Accordingly, the coordination server 28 may not engage in subsequent acts of the method 400 until the coordination server 28 determines that the present time of day falls within the pickup event threshold of the pickup event. In this manner, the coordination server 28 may increase likelihood that at least one of information or data that the coordination server 28 at least one of analyzes, transforms, receives, or provides will be valid at the scheduled time of the pickup event. Accordingly, the coordination server 28 decreases likelihood that the coordination server 28 must repeat such analysis, transformation, reception, or provision, thereby reducing processing or communication resource consumption.

Responsive to the present time of day falling within the threshold of the pickup event, the coordination server 28 may determine the given one of the pickup zones or locations 18 of the given one of the entities to be picked up 8 at 414. The coordination server 28 may identify the given one of the pickup zones or locations 18 that is logically associated with both the given one of the entities to be picked up 8 and the pickup event. For example, the coordination server 28 may identify the given one of the pickup zones or locations 18 that is logically associated with the given one of the grade levels or a given one of a plurality of classifications (e.g., size, weight, priority level) of the given one of the entities to be picked up 8. Additionally or alternatively, the authorized pickup entity content or application may cause the authorized pickup entity graphical user interface to display at least one selectable or editable pickup location input that permits the given one of the authorized entities 12 to select or define the given one of the pickup zones or locations 18. Additionally or alternatively, the coordination server 28 may define the given one of the pickup zones or locations 18 responsive to determining at least one present location of the given one of the entities to be picked up 8 (e.g., via a locator service of at least one electronic device of the given one of the entities to be picked up 8).

The coordination server 28 may determine at least one availability status of the given one of the entities to be picked up 8 at 416. For example, the coordination server 28 may compare the present time of day to the scheduled time of the pickup event. Additionally or alternatively, the coordination server 28 may receive the availability status from the given one of the monitor devices 20. For example, at least one of the monitor content or the monitor application may cause the given one of the monitor devices 20 to include at least one user selectable or editable availability status input with the monitor graphical user interface. The monitor content or application may cause the given one of the monitor devices 20 to provide at least one availability status indicator to the coordination server 28 responsive to at least one selection, edit, manipulation, or submission of the availability status input (e.g., the given one of the monitors 10 may indicate that the given one of the entities to be picked up 8 is ready to be picked up responsive to conclusion of at least one class, activity, arrival, or processing event of the given one of the entities to be picked up 8). The monitor content or application may cause the availability status indicator to indicate whether the given one of the entities to be picked up 8 is available to be picked up. The monitor content or application may cause the given one of the monitor devices 20 to provide the status indicator to the coordination server 28 in at least a similar manner as at least one of those explained above with regard to the given one of the authorized pickup entity devices 22 providing the pickup instructions at 304 of the method 300. The coordination server 28 may determine the availability status to be at least one of “available” or “not available” at least until the coordination server 28 receives the availability status indicator. Accordingly, the coordination server 28 permits the given one of the monitor devices 20 to provide the availability status indicator responsive only to at least one change in the availability status, thereby reducing processing or communication resource consumption. Additionally or alternatively, the coordination server 28 may determine the availability status to be one of “unknown” at least until the coordination server 28 receives the availability status indicator.

The coordination server 28 may provide at least one availability notification or pickup location notification to each given one of the monitors 10 or authorized entities 12 at 418. The availability notification may include information indicative of the availability status. The pickup location notification may include information indicative of the given one of the pickup zones or locations 18. The monitor content or application may cause the monitor graphical user interface to display the pickup location notification. Additionally or alternatively, the monitor content or application may cause the given one of the monitor devices 20 to aurally display the pickup location notification.

Additionally or alternatively, the coordination server 28 may determine each given one of the authorized entities 12. For example, the dismissal or carpool instructions may include information indicative of at least one given one of the authorized entities 12 authorized to pick up the given one of the entities to be picked up 8 (e.g., at least one given one of the authorized entities 12 that created, authored, edited, or submitted the dismissal or carpool instructions, carpool or delivery driver, or other entity that has permanent or temporary permission to pick up the given one of the entities to be picked up 8). Additionally or alternatively, the coordination server 28 may query at least one of the databases stored on nontransitory media 32 for each given one of the authorized entities 12. The coordination server 28 may provide the availability notification or pickup location notification to each respective given one of the authorized pickup entity devices 22 logically associated with each determined given one of the authorized entities 12 (e.g., push to each respective given one of the authorized pickup entity devices 22 or provide to each respective given one of the authorized pickup entity devices 22 responsive to respective availability status pull from each respective given one of the authorized pickup entity devices 22).

For example, responsive to receiving at least one respective authorization (e.g., authorization from parent, legal guardian, addressee, recipient) for at least one respective given one of the authorized entities 12, the coordination server 28 may provide at least one authorization notification to a respective given one of the authorized pickup entity devices 20 logically associated with the respective given one of the authorized entities 12. The authorization notification may cause the respective given one of the authorized pickup entity devices 20 to display at least one authorization indicator that indicates the respective authorization for the respective given one of the authorized entities 12. The coordination server 28 may provide a different notification based at least in part on whether the coordination server 28 determines that the respective given one of the authorized pickup entity devices 20 previously communicably coupled to the coordination server 28. For example, responsive to determining that the coordination server 28 previously communicably coupled to the respective given one of the authorized pickup entity devices 20, the coordination server 28 may provide the authorization notification to the respective given one of the authorized pickup entity devices 20 via at least one of the authorized pickup entity content or application. Responsive to determining that the coordination server 28 did not previously communicably couple to the respective given one of the authorized pickup entity devices 20, the coordination server 28 may provide at least one invitation notification to the respective given one of the authorized pickup entity devices 20. The invitation notification may cause the respective given one of the authorized pickup entity devices 20 to display at least one invitation indicator that indicates the respective authorization and that includes at least one link (e.g., hyperlink) or uniform resource locator (URL). The link or URL may cause at least one element (e.g., at least one browser or application) of the respective given one of the authorized pickup entity devices 20 to obtain (e.g., download, install) at least one of the authorized pickup entity content or authorized pickup entity application. Responsive to the respective given one of the authorized pickup entity devices obtaining the authorized pickup entity content or application, the coordination server 28 may the authorization notification to the respective given one of the authorized pickup entity devices 20 via at least one of the authorized pickup entity content or application.

Additionally or alternatively, the coordination server 28 may provide the availability notification or pickup location notification to less than all of the respective given ones of the authorized pickup entity devices 20. For example, responsive to execution of the authorized pickup entity content or authorized pickup entity application, the invitation notification may cause the respective given one of the authorized pickup entity devices 20 to display at least one availability notification option or pickup location notification option. Additionally or alternatively, the authorized pickup entity content or authorized pickup entity application may cause the respective given one of the authorized pickup entity devices 20 to display at least one of the availability notification option or pickup location notification option at a later point in time (e.g., responsive to user selection via at least one authorized pickup entity menu). At least one of the availability notification option or pickup location notification option may permit the respective given one of the authorized entities 12 to opt in or out of receiving at least one of the availability notification or pickup location notification.

Also for example, the coordination server 28 may determine whether the dismissal or carpool instructions indicate at least one scheduled given one of the authorized entities 12 for at least one scheduled pickup event. The coordination server 28 may provide at least one of the availability notification or pickup location notification to at least one respective given one of the authorized pickup entity devices 20 that is logically associated with each scheduled given one of the authorized entities 12 in at least a similar manner as at least one of those explained above with regard to the respective given ones of the authorized pickup entity devices 12. At least by providing the availability notification or pickup location notification to less than all given ones of the authorized pickup entity devices 20, the coordination server 28 permits conservation of processing or communication resource consumption.

The coordination server 28 may determine at least one estimated time of arrival of the given one of the authorized entities 12 at the given one of the pickup zones or locations 18 at 420. For example, the authorized pickup entity content or authorized pickup entity application may cause the given one of the authorized pickup entity devices 22 to display at least one location service notification or prompt to enable at least one location service (e.g., geolocating via at least one global positioning system of the given one of the authorized pickup entity devices 22) responsive to determining that the location service is not enabled. The authorized pickup entity content or application may cause the given one of the authorized pickup entity devices 22 to provide at least one location indicator to at least one of the estimated time to arrival estimation server 26, coordination server 28, or the administration server 30 in at least a similar manner as at least one of those explained above with regard to the pickup instructions at 304 of the method 300.

For example, the authorized pickup entity content or authorized pickup entity application may cause the given one of the authorized pickup entity devices 22 to obtain location data of the given one of the authorized pickup entity devices 22 via the location service. The location data may indicate geographical coordinates that represent an estimated present location of the given one of the authorized pickup entity devices 22 via the location service. Additionally or alternatively, the location data may indicate at least one rate of speed (e.g., miles per hour, kilometers per hour) of the given one of the authorized pickup entity devices 22. The authorized pickup entity content or authorized pickup entity application may cause the given one of the authorized pickup entity devices 22 to transform the location data into the location indicator. The authorized pickup entity content or authorized pickup entity application may cause the given one of the authorized pickup entity devices 22 to provide the location indicator to at least one of the estimated time to arrival estimation server 26, coordination server 28, or the administration server 30 in at least a similar manner as at least one of those explained above with regard to the pickup instructions at 304 of the method 300. Additionally or alternatively, responsive to receiving the location indicator, at least one of the coordination server 28 or administration server may provide the location indicator to the estimated time to arrival estimation server 26. For example, the estimated time to arrival estimation server 26 may be at least one of owned or operated by at least one third party estimated time of arrival provider. The estimated time to arrival server calculates the estimated time of arrival of the given one of the authorized entities 12 at the given one of the pickup zones or locations 18 based at least in part on the location indicator. For example, the estimated time to arrival estimation server 26 may calculate such also based at least in part on historical, present, or predicted traffic conditions or patterns (e.g., via the haversine formula, historical average for a given route, look up table for the given route). Additionally or alternatively, the authorized pickup entity content or authorized pickup entity application may cause the given one of the authorized pickup entity devices 22 to calculate the estimated time to arrival of the given one of authorized entities 12 based at least in part on the location data. The authorized pickup entity content or authorized pickup entity application may cause the given one of the authorized pickup entity devices 22 to provide the calculated estimated time to arrival as the location indicator to at least one of the coordination server 28 or administration server 30.

Responsive to obtaining the location indicator, the coordination server 28 may determine at least one estimated time to arrival status of the given one of the authorized entities 12 at 422. An estimated time to arrival status (e.g., “en route,” “approaching,” “here,” “waiting”) is different than the estimated time to arrival. In particular, an estimated time to arrival is a numerical value (e.g., an amount of time). In contrast, an estimated time to arrival status is a descriptor of the estimated time to arrival. The coordination server 28 may compare at least one estimated distance between the given one of the authorized pickup entity devices 22 and the given one of the pickup zones or locations 18 (e.g., as defined by a geofence that the coordination server 28 logically associates in at least one of the databases 32 with the given one of the pickup zones or locations 18) to at least one predetermined distance threshold. For example, the coordination server 28 may calculate that the estimated time to arrival status is “en route” responsive to the estimated distance being greater than a first predefined distance threshold (e.g., 2,500 feet). The coordination server 28 may calculate that the estimated time to arrival status is “approaching” responsive to the estimated distance being no less than a second predefined distance threshold (e.g., 50 feet) and no greater than the first predefined distance threshold. The coordination server 28 may calculate that the estimated time of arrival status is “here” responsive to the estimated distance being less than the second predefined distance threshold. Additionally or alternatively, the coordination server 28 may compare the estimated time to arrival to at least one predetermined time of arrival threshold. For example, the coordination server 28 may calculate that the estimated time of arrival status is “en route” responsive to the estimated time to arrival being greater than a first predetermined time to arrival threshold (e.g., five minutes). The coordination server 28 may calculate that the estimated time of arrival status is “approaching” responsive to the estimated time to arrival being no less than a second predetermined time to arrival threshold (e.g., one minute) and no greater than the first predetermined time to arrival threshold. The coordination server 28 may calculate that the estimated time to arrival status is “here” responsive to the estimated time to arrival being less than the second predetermined time to arrival threshold. Additionally or alternatively, the given one of the vehicles 14 or authorized pickup entity devices 22 may have at least one component (e.g., at least one of the communications interfaces 282) that interacts with at least a first interrogator (not shown). For example, at least one entrance of the given one of the facilities 6 or pickup zones or locations 18 may have the first interrogator. The first interrogator may detect at least one of approach, presence, or passage of such component, thereby detecting that the estimated time to arrival status is “here.” Responsive to the coordination server 28 calculating that the estimated time of arrival status is “here,” the coordination server 28 may initiate a timer count (e.g., timer count up, timer count down). The coordination server 28 may calculate that the estimated time of arrival status is “waiting” responsive to the timer count indicating that the given one of the authorized pickup entity devices 22 has at least one arrival status of “here” for at least one predetermined presence threshold (e.g., one minute).

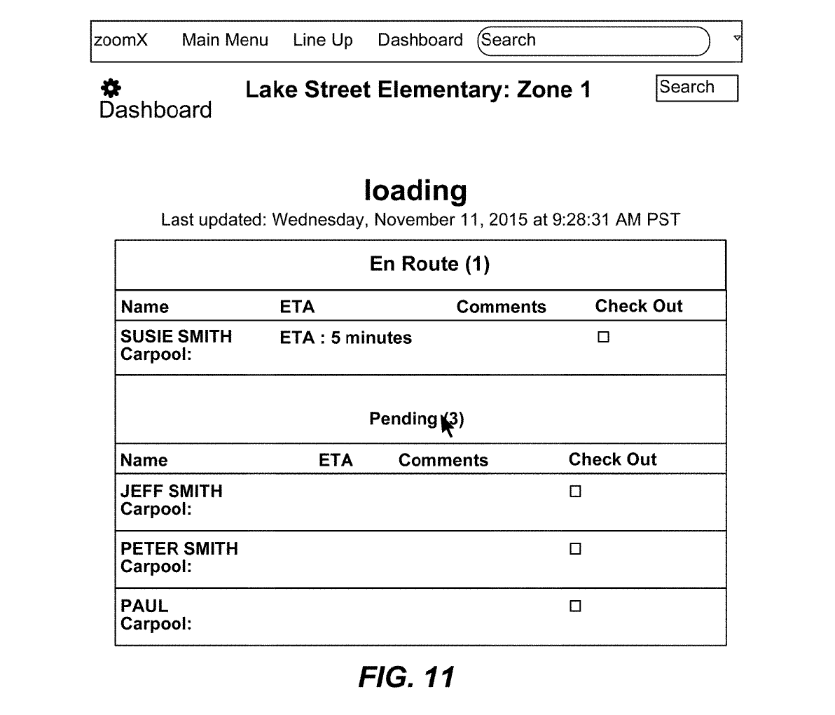

Responsive to calculating at least one of the estimated time to arrival or the estimate time to arrival status, the coordination server 28 may provide at least one of the estimated time to arrival or estimate time to arrival status to the relevant entities at 424. For example, the coordination server 28 may provide the estimated time to arrival or estimate time to arrival status to the relevant entities as explained above with regard to the parsed pickup instructions of the method 300 (e.g., as explained above with regard to at least one of acts 306-310 of the method 300). The monitor content or application may cause the monitor graphical user interface to display at least one of the estimated time to arrival or estimate time to arrival status in a manner that corresponds to the given one of the entities to be picked up (e.g., shared row, shared field, color coded). Additionally or alternatively, the monitor content or application may cause the given one of the monitor devices 20 to haptically or aurally display at least one of the estimated time to arrival or estimate time to arrival status in a manner that corresponds to the given one of the entities to be picked up (e.g., autonomously announce the estimated time to arrival or estimated time to arrival status of the given one of the authorized entities 12). For example, FIGS. 11-13 show respective screen shots of example instances of the monitor graphical user interface that may include at least one estimated time to arrival status or estimated time to arrival.

The coordination server 28 may determine whether pickup of the given one of the entities 8 to be picked up is complete for the pickup event at 426. For example, at least one of the monitor content or the monitor application may cause the given one of the monitor devices 20 to include at least one selectable pickup completion input with the monitor graphical user interface. The monitor content or application may cause the given one of the monitor devices 20 to provide at least one pickup completion indicator to the coordination server 28 responsive to a selection, edit, manipulation, or submission of the completion input (e.g., the given one of the monitors 10 may indicate that the given one of the authorized entities 12 completed picked up the given one of the entities to be picked up 8). The monitor content or application may cause the given one of the monitor devices 20 to provide the pickup completion indicator to the coordination server 28 in at least a similar manner as at least one of those explained above with regard to provision of the availability indicator at 416 of the method 400. The coordination server 28 may determine the pickup completion status to be at least one of “picked up” or “not picked up” at least until the coordination server 28 receives the pickup completion indicator. Accordingly, the coordination server 28 permits the given one of the monitor devices 20 to provide the pickup completion indicator responsive only to a change in such status, thereby reducing processing or communication resource consumption. Additionally or alternatively, the coordination server 28 may determine the pickup completion status to be one of “unknown” at least until the coordination server 28 receives the pickup completion indicator.

Additionally or alternatively, the coordination server 28 may determine whether pickup is complete for the pickup event by calculating such. For example, responsive to the coordination server 28 determining that the estimated time to arrival status of the given one of the authorized entities 12 is one of “here” or “waiting” for at least one predetermined presence threshold (e.g., 10 seconds, 20 seconds, 30 seconds, one minute, two minutes), the coordination server 28 may iteratively compare the estimated present location of the given one of the authorized pickup entity devices 22 to the estimated location of the given one of the pickup zones or locations 18. Responsive to the coordination server 28 determining that the present estimated distance between the estimated present location of the given one of the authorized pickup entity devices 22 and the estimated location of the given one of the pickup zones or locations 18 exceeds at least an immediately prior estimated distance (e.g., at least twice in a row or by more than a predetermined amount), the coordination server 28 may determine that the pickup is complete for the pickup event.

Additionally or alternatively, the given one of the vehicles 14 or authorized pickup entity devices 22 may have at least one component (e.g., at least one of the communications interfaces 282) that interacts with at least a second interrogator (not shown) that, for example, may be the first interrogator or separate from the first interrogator. For example, at least one exit (e.g., an exit distinct from the entrance, an exit indistinct from the entrance) of the given one of the facilities 6 or pickup zones or locations 18 may have the second interrogator. The interrogator may detect approach, presence, or passage of such component, thereby detecting completion of the pickup event.

Responsive to a lack of a determined completion of the pickup for the pickup event, the coordination server 28 may repeat at least one portion of at least one act of 414-426.

Responsive to a determined completion of the pickup for the pickup event, the coordination server 28 may generate at least one untamperable date or time stamp 34 at 428. For example, the untamperable date or time stamp 34 may be non-editable by any of the monitor devices 20 or authorized pickup entity devices 22. Accordingly, at least compared to an entry that a human may write into a spread sheet or a log, the coordination server 28 increases reliability and increases security of at least one of the entities to be picked up 8, monitors 10, authorized entities 12, monitor devices 20, or authorized pickup entity devices 22.

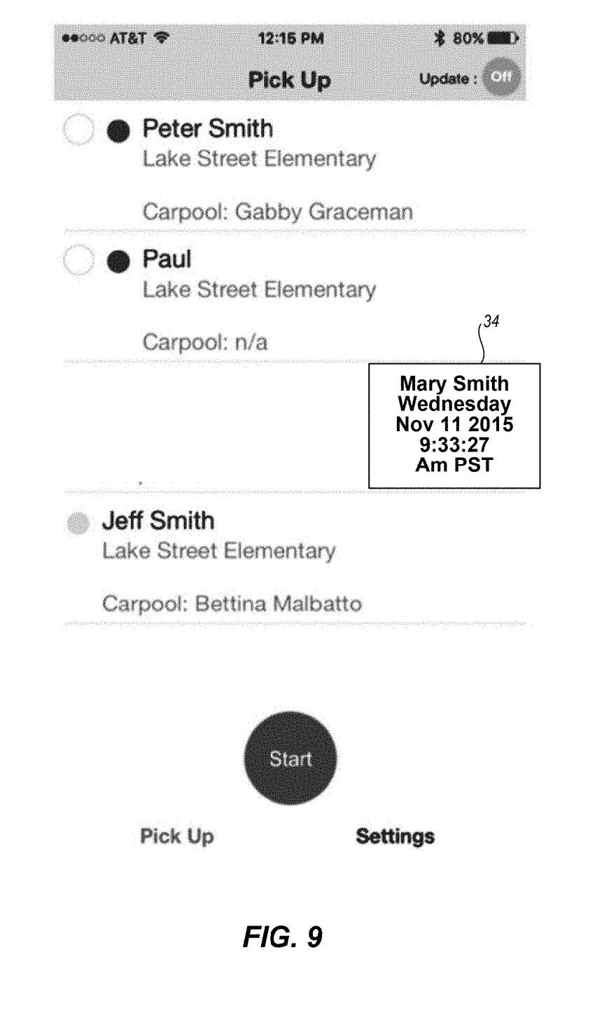

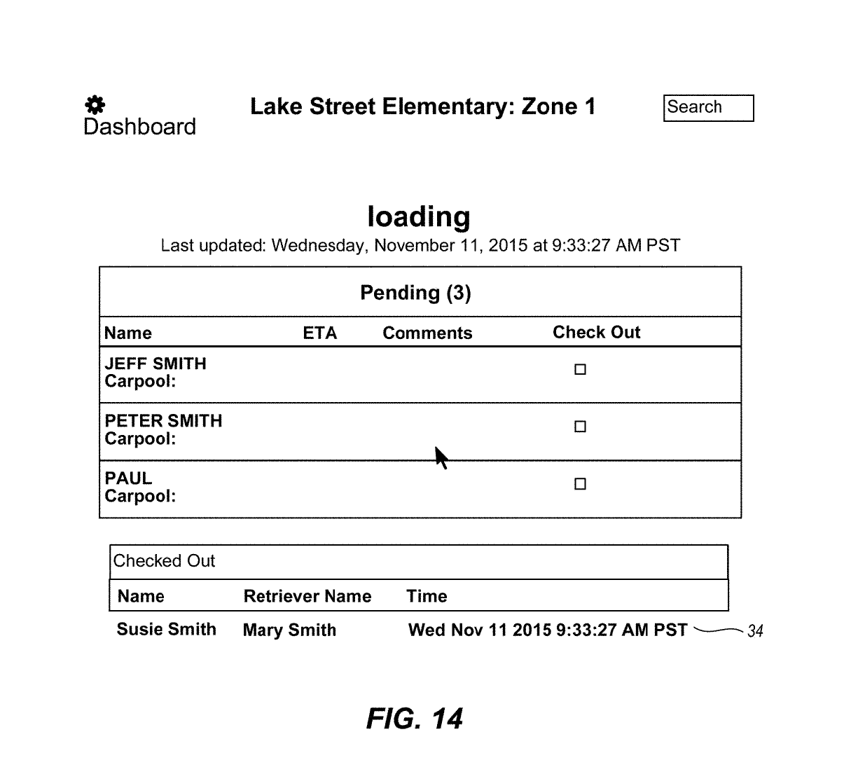

Responsive to generating the untamperable date or time stamp 34, the coordination server 28 may provide the untamperable date or time stamp 34 to at least one requesting entity at 430. The untamperable date or time stamp 34 may indicate at least one of where the given one of the entities 8 to be picked up was picked up (e.g., the given one of the pickup zones or locations 18), who picked up the given one of the entities to be picked up 8, or when the given one of the entities to be picked up 8 was picked up. For example, the coordination server 28 may provide the untamperable date or time stamp 34 to at least one requesting given one of the authorized entities 12 in at least a similar manner as at least one of those explained above with regard to the availability indicator or pickup location indicator at 418. Responsive to the untamperable date or time stamp 34, the authorized pickup entity content or application may cause the given one of the authorized pickup entity devices 22 to disable at least one portion of the location services. Additionally or alternatively, the coordination server 28 may provide the untamperable date or time stamp 34 to the given one of the monitors 10 by providing the untamperable date or time stamp 34 to the given one of the monitor devices 20 as explained above with regard to the parsed pickup instructions of the method 300 (e.g., as explained above with regard to at least one of acts 306-310 of the method 300). The monitor content or application may cause the given one of the monitor devices 20 to display at least one of live or archived indicators with regard to at least one portion of the subject matter explained herein (e.g., for one of the entities 8 to be picked up at a time, for concurrently all of the entities to be picked up 8 logically associated with the given one of the monitors 10). For example, FIG. 9 shows a screen shot of an example instance of the authorized pickup entity graphical user interface that may include the untamperable date or time stamp 34. Also for example, FIG. 14 shows a screen shot of an example instance of the monitor graphical user interface that may include the untamperable date or time stamp 34.

The method 400 may end at 432. In some implementations, the method 400 may operate continuously, or may operate as a plurality of threads of a multi-threaded process operating on suitable processor(s) (e.g., multi-core processor(s)).

The coordination server 28 may logically associate in at least one of the databases 32 the given one of the entities to be picked up 8 with at least one target device (not shown). At least one portion of the subject matter explained herein with regard to the monitor devices 20 may apply to the target device yet with limited capacity. For example, the monitor content or application may include specific programming that causes the target device to lack capacity to select completion of the pickup event.

At least one of the authorized pickup entity content or application or monitor content or application may cause at least one of the authorized pickup entity graphical user interface or monitor graphical user interface to display scheduled pickup events for previous days, present day, or future days. For example, such may display with at least one other portion of the subject matter explained herein.

At least one portion of the subject matter explained herein with regard to the monitor devices 20 may apply to the administration server 30 yet with increased capacity. For example, the administration server 30 may access all data for that each of the monitor devices 20 logically associated with the administration server 30 may access. For example, the coordination server 28 may provide historical pickup data to the administration server 30. The administration server 30 may display statistical data pertaining to pick up efficiency of such ones of the monitors 10 (e.g., mean, median, variance, minimum, maximum, etc. of waiting time of at least one of all authorized entities 12, selected or filtered authorized entities 12, all entities to be picked up 8, selected or filtered entities 8 to be picked up, all monitors 10, selected or filtered monitors 10, all pickup events, selected or filtered pickup events).

Additionally or alternatively to at least one of the method 300, the method 400, at least one of acts 302-312, or at least one of acts 402-432, the system 1 may coordinate at least the pickup event.

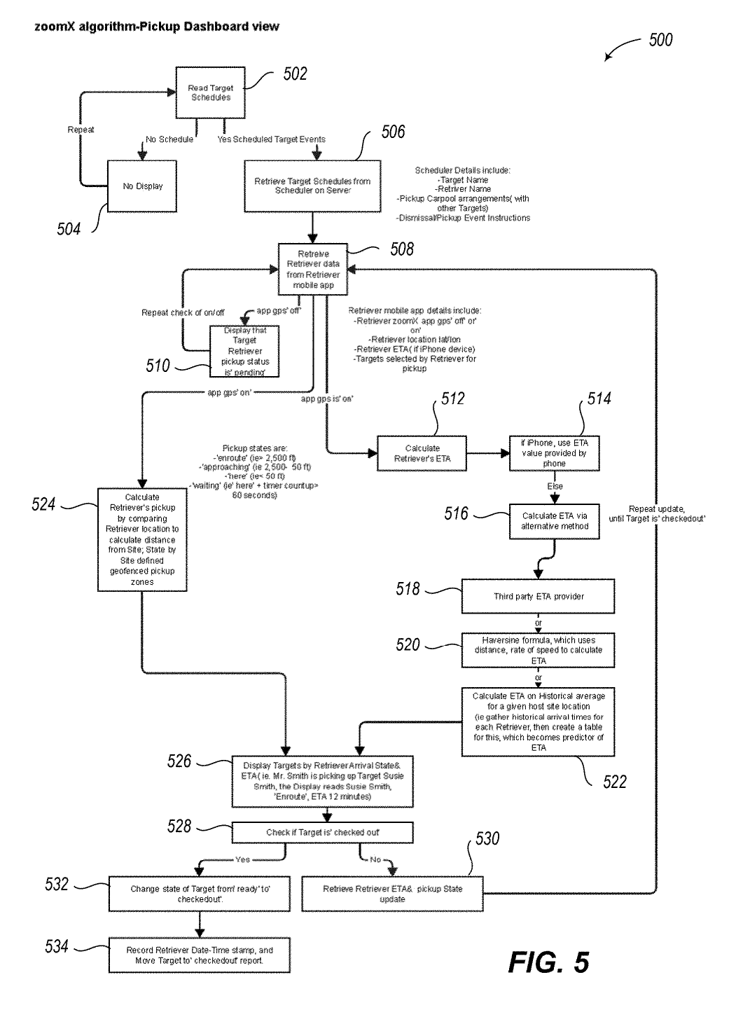

FIG. 5 shows a high level flow diagram of a coordination of pickups method 500 executable by the various components of the system of FIG. 1, according to at least one illustrated implementation.

The method 500 permits interaction between the monitor devices and authorized pickup entity devices while maintaining privacy of entities logically associated with such devices, and while addressing a plurality of technical problems that one of ordinary skill in the art may face when implementing the system of FIG. 1.

The method 500 starts at 502. For example, at least one of the given one of the monitor devices 20, authorized pickup entity devices 22, coordination server 28, or administration server 30 may read at least one pickup schedule from at least one of the databases 32 for at least the given one of the entities to be picked up 8 at 502. At least one of the given one of the monitor devices 20, authorized pickup entity devices 22, coordination server 28, or administration server 30 may determine whether at least one of the databases 32 includes at least one pickup schedule for the given one of the entities to be picked up 8.

Responsive to determining that the at least one database 32 does not have any pickup schedule for the given one of the entities to be picked up 8, at least one of the given one of the monitor devices 20, authorized pickup entity devices 22, coordination server 28, or administration server 30 may take no action at 504. Additionally or alternatively, at least one of the given one of the monitor devices 20, authorized pickup entity devices 22, coordination server 28, or administration server 30 may initiate creation of at least one pickup schedule for the given one of the entities to be picked up 8. For example, at least one of the given one of the monitor devices 20, authorized pickup entity devices 22, coordination server 28, or administration server 30 may cause at least one of the monitor content or application or authorized pickup entity content or application to prompt a respective one of the given one of the monitors 10 or authorized entities 12 to create the pickup schedule for the given one of the entities to be picked up 8. Responsive to creation of the pickup schedule, the at least one of the monitor content or application or authorized pickup entity content or application may cause a respective one of the given one of the monitor devices 20 or authorized pickup entity devices 22 to provide the pickup schedule to at least one of the given one of the monitor devices 20, authorized pickup entity devices 22, coordination server 28, or administration server 30 in at least a similar manner as at least one of those explained above with regard to the method 400 (e.g., at least one portion of at least one of acts 404-410, 418, 424, 430).

Responsive to determining that the at least one database 32 has at least one pickup schedule for the given one of the entities to be picked up 8, at least one of the given one of the monitor devices 20, authorized pickup entity devices 22, coordination server 28, or administration server 30 may retrieve the schedule from the at least one of the databases 32 at 506. For example, at least one of the given one of the monitor devices 20, authorized pickup entity devices 22, coordination server 28, or administration server 30 may retrieve the pickup schedule from the at least one of the databases 32 in at least a similar manner as at least one of those explained above with regard to the method 400 (e.g., at least one portion of at least one of acts 404-410, 418, 424, 430).

Responsive to retrieving the pickup schedule, at least one of the given one of the monitor devices 20, authorized pickup entity devices 22, coordination server 28, or administration server 30 may retrieve at least one of the pickup, dismissal, or carpool instructions at 508. For example, at least one of the given one of the monitor devices 20, authorized pickup entity devices 22, coordination server 28, or administration server 30 may retrieve such from at least one of the databases stored on nontransitory processor-readable media 32 or the given one of the authorized pickup entity devices 22 in at least a similar manner as at least one of those explained above with regard to the method 400 (e.g., at least one portion of at least one of acts 404-410, 418, 424, 430).

Responsive to retrieving at least one of the pickup, dismissal, or carpool instructions, at least one of the given one of the monitor devices 20, authorized pickup entity devices 22, coordination server 28, or administration server 30 may determine whether the given one of the authorized pickup entity devices 22 has at least one location service enabled (e.g., global positioning service). Responsive to determining that the given one of the authorized pickup entity devices 22 does not have at least one location service enabled, at least one of the given one of the monitor devices 20, authorized pickup entity devices 22, coordination server 28, or administration server 30 may display the pickup status of the given one of the authorized pickup entity devices 22 as “pending” at 510.

Responsive to determining that the given one of the authorized pickup entity devices 22 has at least one location service enabled, at least one of the given one of the monitor devices 20, authorized pickup entity devices 22, coordination server 28, or administration server 30 may calculate the estimated time to arrival of the given one of the authorized pickup entity devices 22 at 512. At least one of the given one of the monitor devices 20, authorized pickup entity devices 22, coordination server 28, or administration server 30 may calculate such in at least a similar manner as at least one of those explained above with regard to the method 400 (e.g., at least one portion of at least one of acts 414-422).

At least one of the given one of the monitor devices 20, authorized pickup entity devices 22, coordination server 28, or administration server 30 may determine whether the given one of the authorized pickup entity devices 22 is capable of calculating the estimated time to arrival value at 514. For example, at least one of the given one of the monitor devices 20, authorized pickup entity devices 22, coordination server 28, or administration server 30 may determine whether the given one of the authorized pickup entity devices 22 is an iPhone by Apple®.

Responsive to determining that the given one of the authorized pickup entity devices 22 is not capable of calculating the estimated time to arrival value, at least one of the given one of the monitor devices 20, authorized pickup entity devices 22, coordination server 28, or administration server 30 may calculate the estimated time to arrival value at 516. For example, at least one of the given one of the monitor devices 20, authorized pickup entity devices 22, coordination server 28, or administration server 30 may calculate such in at least a similar manner as at least one of those explained above with regard to the method 400 (e.g., at least one portion of at least one of acts 414-422).

Additionally or alternatively, at least one of the given one of the monitor devices 20, authorized pickup entity devices 22, coordination server 28, or administration server 30 may cause at least one third party estimated time to arrival provider (e.g., the estimated time to arrival server 26) to calculate and return the estimated time to arrival value at 518. For example, at least one of the given one of the monitor devices 20, authorized pickup entity devices 22, coordination server 28, or administration server 30 may do such in at least a similar manner as at least one of those explained above with regard to the method 400 (e.g., at least one portion of at least one of acts 414-422).

Additionally or alternatively, at least one of the given one of the monitor devices 20, authorized pickup entity devices 22, coordination server 28, or administration server 30 may calculate the estimated time to arrival via the haversine formula at 520. For example, at least one of the given one of the monitor devices 20, authorized pickup entity devices 22, coordination server 28, or administration server 30 may do such in at least a similar manner as at least one of those explained above with regard to the method 400 (e.g., at least one portion of at least act 420).

Responsive to obtaining the estimated time to arrival, at least one of the given one of the monitor devices 20, authorized pickup entity devices 22, coordination server 28, or administration server 30 may calculate the estimated time to arrival status at 522. For example, at least one of the given one of the monitor devices 20, authorized pickup entity devices 22, coordination server 28, or administration server 30 may do such in at least a similar manner as at least one of those explained above with regard to the method 400 (e.g., at least one portion of at least act 422). Additionally or alternatively, at least one of the given one of the monitor devices 20, authorized pickup entity devices 22, coordination server 28, or administration server 30 may calculate the estimated time to arrival status in parallel to at least one portion of at least one of acts 512-522. For example, at least one of the given one of the monitor devices 20, authorized pickup entity devices 22, coordination server 28, or administration server 30 may calculate the estimated time to arrival status based at least in part on a prior estimated time to arrival that at least one of the given one of the monitor devices 20, authorized pickup entity devices 22, coordination server 28, or administration server 30 obtained in at least one immediately prior iteration of at least one portion of at least one act of the method 500.

Responsive to obtaining at least one of the estimated time to arrival value or estimated time to arrival status, at least one of the given one of the monitor devices 20, authorized pickup entity devices 22, coordination server 28, or administration server 30 may display at least one identifier of at least one of the entities 8 to be picked up, including the given one of the entities to be picked up 8, at 526. For example, at least one of the given one of the monitor devices 20, authorized pickup entity devices 22, coordination server 28, or administration server 30 may do such in at least a similar manner as at least one of those explained above with regard to the method 400 (e.g., at least one portion of at least one of acts 406, 410, 414, 418, 424, 430). Such may include display of at least one estimated time to arrival status, estimated time to arrival, or identifier of the given one of the authorized entities 12.

At least one of the estimated time to arrival value or estimated time to arrival status, at least one of the given one of the monitor devices 20, authorized pickup entity devices 22, coordination server 28, or administration server 30 may determine whether the given one of the entities to be picked up 8 has been picked up at 528. For example, at least one of the given one of the monitor devices 20, authorized pickup entity devices 22, coordination server 28, or administration server 30 may do such in at least a similar manner as at least one of those explained above with regard to the method 400 (e.g., at least one portion of at least act 426).

Responsive to determining that the given one of the entities to be picked up 8 is not picked up, at least one of the given one of the monitor devices 20, authorized pickup entity devices 22, coordination server 28, or administration server 30 may retrieve at least one update to at least one of the estimated time to arrival or the estimated time to arrival status at 530. For example, such may involve repeating at least one portion of at least one of acts 508-528. At least one of the given one of the monitor devices 20, authorized pickup entity devices 22, coordination server 28, or administration server 30 may do such in at least a similar manner as at least one of those explained above with regard to the method 400 (e.g., at least one portion of at least act 426).

Responsive to determining that the given one of the entities to be picked up 8 is picked up, at least one of the given one of the monitor devices 20, authorized pickup entity devices 22, coordination server 28, or administration server 30 may change the pickup completion status to be “picked up” or “checked out” at 532. For example, at least one of the given one of the monitor devices 20, authorized pickup entity devices 22, coordination server 28, or administration server 30 may do such in at least a similar manner as at least one of those explained above with regard to the method 400 (e.g., at least one portion of at least act 426).

Responsive to at least determining that the given one of the entities to be picked up 8 is picked up, at least one of the given one of the monitor devices 20, authorized pickup entity devices 22, coordination server 28, or administration server 30 may record the untamperable date or time stamp 34 at 534. For example, at least one of the given one of the monitor devices 20, authorized pickup entity devices 22, coordination server 28, or administration server 30 may do such in at least a similar manner as at least one of those explained above with regard to the method 400 (e.g., at least one portion of at least one of acts 428 or 430). Additionally or alternatively, at least one of the given one of the monitor devices 20, authorized pickup entity devices 22, coordination server 28, or administration server 30 may move the identifier of the given one of the entities to be picked up 8 to at least one picked up or checked out report. For example, at least one of the given one of the monitor devices 20, authorized pickup entity devices 22, coordination server 28, or administration server 30 may do such in at least a similar manner as at least one of those explained above with regard to the method 400 (e.g., at least one portion of at least one of acts 426-430).

The method 500 may end at 534. In some implementations, the method 500 may operate continuously, or may operate as a plurality of threads of a multi-threaded process operating on suitable processor(s) (e.g., multi-core processor(s)).

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other systems, not necessarily the exemplary systems generally described above.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via application-specific integrated circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

While various exemplary methods and algorithms are described above, it is noted that in each method or algorithm certain acts may be omitted and/or additional acts may be added. Those of skill in the art will also appreciate that the illustrated order of the acts is shown for exemplary purposes, and the order of acts may change in alternative embodiments.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

While examples are explained in terms of one or more databases, in some implementations other collections of data may be employed, such collections of data generally being denominated as data stores.

This application incorporates herein the contents of U.S. provisional patent application Ser. No. 62/330,725 in its entirety. In addition, those skilled in the art will appreciate that the mechanisms taught herein are capable of being distributed as a program product in a variety of forms, and that an illustrative implementation applies equally regardless of the particular type of non-transitory processor-readable media used to actually carry out the distribution.

The various implementations described above can be combined to provide further implementations. Aspects of the implementations can be modified, if necessary, to employ systems, circuits, and concepts to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of coordinating pickups, the method comprising:
for each of a plurality of entities to be picked up, storing respective pickup instructions to at least one nontransitory computer-readable medium, the stored pickup instructions which specify an entity authorized to pick up the respective entity to be picked up; and
at least within a first threshold time of a scheduled pickup:
determining, by at least one processor, an estimated time to arrival of the entity authorized to pick up the respective entity to be picked up; and
providing, by at least one processor, the estimated time to arrival of the entity authorized to pick up the respective entity to be picked up to a device logically associated with a monitor entity that monitors the respective entity to be picked up until the respective entity to be picked up is picked up by the entity authorized to pick up the respective entity to be picked up.

2. The method of claim 1, further comprising:
repeatedly determining, by at least one processor, an updated estimated time to arrival of the entity authorized to pick up the respective entity to be picked up; and
repeatedly providing, by at least one processor, the updated estimated time to arrival of the entity authorized to pick up the respective entity to be picked up to the device logically associated with the monitor entity that monitors the respective entity to be picked up until the respective entity to be picked up is picked up by the entity authorized to pick up the respective entity to be picked up.

3. The method of claim 2 wherein repeatedly determining an updated estimated time to arrival of the entity authorized to pick up the respective entity to be picked up includes tracking a location of a wireless communications device logically associated with the entity authorized to pick up the respective entity to be picked up.

4. The method of claim 3 wherein repeatedly determining an updated estimated time to arrival of the entity authorized to pick up the respective entity to be picked up further includes determining an estimated transit time to a pickup location from the location of the wireless communications device logically associated with the entity authorized to pick up the respective entity to be picked up based at least in part on a set of current traffic conditions on a projected route.

5. The method of claim 1, further comprising:
for each of entities to be picked up, determining, by at least one processor, an identifier for the monitor entity that monitors the respective entity to be picked up;
determining, by at least one processor, an identifier of the device logically associated with the monitor entity that monitors the respective entity to be picked up; and
pushing a set of estimated time of arrival information to the device logically associated with the monitor entity that monitors the respective entity to be picked up.

6. The method of claim 1, further comprising:
determining, by at least one processor, an estimated arrival status for the entity authorized to pick up the respective entity to be picked up; and
providing, by at least one processor, the determined estimated arrival status of the entity authorized to pick up the respective entity to be picked up to the device logically associated with the monitor entity that monitors the respective entity to be picked up until the respective entity to be picked up is picked up by the entity authorized to pick up the respective entity to be picked up.

7. The method of claim 6 wherein:
determining an estimated arrival status for the entity authorized to pick up the respective entity to be picked up includes determining the estimated arrival status for the entity authorized to pick up the respective entity to be picked up based at least in part on a current estimated time to arrival of the entity authorized to pick up the respective entity to be picked up; and
providing the determined estimated arrival status of the entity authorized to pick up the respective entity to be picked up to the device logically associated with the monitor entity that monitors the respective entity to be picked up includes pushing the determined estimated arrival status of the entity authorized to pick up the respective entity to be picked up to the device logically associated with the monitor entity that monitors the respective entity to be picked up via at least one wireless communications network.

8. The method of claim 6 wherein:
determining an estimated arrival status for the entity authorized to pick up the respective entity to be picked up includes selecting from three available estimated arrival status, a first indicative that the entity authorized to pick up the respective entity to be picked up is en route, the second indicative that entity authorized to pick up the respective entity to be picked up is approaching a pickup location, and the second indicative that the entity authorized to pick up the respective entity to be picked up is at the pickup location.

9. The method of claim 1, further comprising:
receiving information from the device logically associated with the monitor entity that monitors the respective entity to be picked up, the received information indicative of that the respective entity to be picked up has been picked up; and
in response to the received information, updating, by at least one processor, a pickup status of the respective entity to be picked up.

10. The method of claim 9, further comprising:
in response to the received information, generating a date and time stamp indicative of a date and time of a pickup of the respective entity to be picked up.

11. The method of claim 1, further comprising:
detecting a departure of the device logically associated with the entity authorized to pick up the respective entity to be picked up; and
in response to the detected departure of device logically associated with the entity authorized to pick up the respective entity to be picked up, updating, by at least one processor, a pickup status of the respective entity to be picked up.

12. The method of claim 1, further comprising:
in response to the detected departure of device logically associated with the entity authorized to pick up the respective entity to be picked up, generating, by at least one processor, an untamperable date and time stamp indicative of a date and time of a pickup of the respective entity to be picked up.

13. The method of claim 1, further comprising:
for each of a first number of the entities to be picked up, logically associating, by at least one processor, the respective entity with a first loading location of a plurality of loading locations; and
for each of a second number of the entities to be picked up, logically associating, by at least one processor, the respective entity with a second loading location of the plurality of loading locations.

14-15. (canceled)

16. The method of claim 13, further comprising:
in response to the input indicative of the selection of the first loading location, causing a display of a respective identifier for each of the first number of the entities to be picked up along with an identifier that identifies the entity authorized to pick up the respective entity to be picked, an estimated time of arrival of the entity authorized to pick up the respective entity to be picked, and a user selectable icon, selection of which causes transmission of information indicative of that the respective entity to be picked up has been picked up.

17. The method of claim 1, further comprising:
receiving information from the device logically associated with the monitor entity that monitors the respective entity to be picked up, the received information indicative of that the respective entity to be picked up is ready to be picked up; and
in response to the received information, updating, by at least one processor, an availability status of the respective entity to be picked up, the availability status indicative of whether or not the respective entity to be picked up is available for pick up.

18. The method of claim 17, further comprising:
providing the availability status of the respective entity to be picked up to a wireless communications device logically associated with the entity authorized to pick up the respective entity to be picked up.

19. The method of claim 1, further comprising:
for at least one of the entities to be picked up, receiving a set of updated pickup instructions; and
pushing the updated pickup instructions to the device logically associated with the monitor entity that monitors the respective entity to be picked up.

20. The method of claim 1, wherein the entities to be picked up are students, and further comprising:
in response to an input indicative of at least one of: (i) a selection of a specific instructor, (ii) a selection of a specific grade level, or a selection of a specific type of pick up instruction, causing a display of a respective identifier and associated pick up information for each of a number of the entities to be picked up who are logically associated in at least one computer-readable media with a respective one or more of: (i) the specific instructor, (ii) the specific grade level, or (iii) the specific type of pick up instruction.

21-22. (canceled)

23. The method of claim 1, wherein the entity authorized to pick up the respective entity to be picked up is one of a parent or a caregiver, and further comprising:
in response to an input indicative of a selection of a specific carpool, causing a display of a respective identifier and associated pick up information for each of a number of the entities to be picked up who are logically associated in at least one computer-readable media with the specific carpool.

24. The method of claim 1, wherein storing respective pickup instructions to at least one nontransitory computer-readable medium which specify an entity authorized to pick up the respective entity to be picked up includes storing information that identifies a respective car pool.

25. The method of claim 1, wherein the entities to be picked up are packages.

26. A system that coordinates pickups, the system comprising:
at least one processor;
at least one non-transitory computer-readable medium communicatively coupled to the at least one processor, the at least one non-transitory computer-readable medium which stores at least one of processor-executable instructions or data, which when executed by the at least one processor cause the at least one processor to:
for each of a plurality of entities to be picked up, store respective pickup instructions to the at least one nontransitory computer-readable medium, the stored pickup instructions which specify an entity authorized to pick up the respective entity to be picked up; and
at least within a first threshold time of a scheduled pickup:
determine an estimated time to arrival of the entity authorized to pick up the respective entity to be picked up; and
provide the estimated time to arrival of the entity authorized to pick up the respective entity to be picked up to a device logically associated with a monitor entity that monitors the respective entity to be picked up until the respective entity to be picked up is picked up by the entity authorized to pick up the respective entity to be picked up.

27. The system of claim 26 wherein, when executed, the processor-executable instructions or data, further cause the at least one processor to:
repeatedly determine an updated estimated time to arrival of the entity authorized to pick up the respective entity to be picked up; and
repeatedly provide the updated estimated time to arrival of the entity authorized to pick up the respective entity to be picked up to the device logically associated with the monitor entity that monitors the respective entity to be picked up until the respective entity to be picked up is picked up by the entity authorized to pick up the respective entity to be picked up.

28. The system of claim 27 wherein to repeatedly determine an updated estimated time to arrival of the entity authorized to pick up the respective entity to be picked up the at least one processor tracks a location of a wireless communications device logically associated with the entity authorized to pick up the respective entity to be picked up.

29. The system of claim 28 wherein to repeatedly determine an updated estimated time to arrival of the entity authorized to pick up the respective entity to be picked up the at least one processor further determines an estimated transit time to a pickup location from the location of the wireless communications device logically associated with the entity authorized to pick up the respective entity to be picked up based at least in part on a set of current traffic conditions on a projected route.

30. The system of claim 26 wherein, when executed, the processor-executable instructions or data, further cause the at least one processor to:
for each of entities to be picked up, determine an identifier for the monitor entity that monitors the respective entity to be picked up;
determine an identifier of the device logically associated with the monitor entity that monitors the respective entity to be picked up; and
push a set of estimated time of arrival information to the device logically associated with the monitor entity that monitors the respective entity to be picked up.

31-50. (canceled)
